(19) United States
(12) Patent Application Publication
(10) Pub. No.: US 2025/0062966 A1
(43) Pub. Date: Feb. 20, 2025

(54) INFORMATION PROCESSING APPARATUS, INFORMATION PROCESSING METHOD, AND COMPUTER PROGRAM PRODUCT

(71) Applicant: KABUSHIKI KAISHA TOSHIBA, Tokyo (JP)

(72) Inventors: Kenji HIROHATA, Koto Tokyo (JP); Akira KANO, Kawasaki Kanagawa (JP); Shotaro OKA, Shinjuku Tokyo (JP); Ryuji TAKAHASHI, Kawasaki Kanagawa (JP); Makihiko ISHITANI, Yokohama Kanagawa (JP); Hideaki UEHARA, Yokohama Kanagawa (JP)

(73) Assignee: KABUSHIKI KAISHA TOSHIBA, Tokyo (JP)

(21) Appl. No.: 18/761,839

(22) Filed: Jul. 2, 2024

(30) Foreign Application Priority Data
Aug. 18, 2023 (JP) 2023-133470

(51) Int. Cl. H04L 41/14; H04L 41/142; H04L 43/022

(52) U.S. Cl. CPC H04L 41/145; H04L 41/142; H04L 43/022

(57) ABSTRACT

An information processing apparatus according to an embodiment includes a processor. The processor extracts multiple features representing characteristics of pieces of second sampling data. The pieces of second sampling data include pieces of first sampling data and pieces of output data obtained by using the pieces of first sampling data as input. The pieces of first sampling data are generated by using a multidimensional first probability distribution representing a distribution of each of pieces of input data related to an object to be analyzed. The pieces of output data represent physical quantity of the object to be analyzed. The processor generates a network model representing a relationship among multiple nodes corresponding to the physical quantity of the object to be analyzed. The multiple nodes include a node corresponding to the extracted features.

### CROSS-REFERENCE TO RELATED APPLICATIONS

This application is based upon and claims the benefit of priority from Japanese Patent Application No. 2023-133470, filed on Aug. 18, 2023; the entire contents of which are incorporated herein by reference.

### FIELD

Embodiments described herein relate generally to an information processing apparatus, an information processing method, and a computer program product.

### BACKGROUND

Resilience management based on the concept of Safety-II including prediction, monitoring, response, and learning is expected to reduce downtime and improve availability of infrastructure systems that are an example of complex systems.

Methods are needed to improve the resilience of complex systems to disturbances (such as reducing system downtime) on the basis of the concept of Safety-II, and to implement analysis, visualization, and control for appropriate resilience management.

For achieving a circular economy, methods are also needed to implement analysis, visualization, and control that enable the juxtaposition of multiple values such as environmentality, economic efficiency, and resilience.

### BRIEF DESCRIPTION OF THE DRAWINGS

FIG. 1 is a schematic block diagram of an information processing system of an embodiment;

FIG. 2 is a schematic block diagram of an analyzer;

FIG. 3 is a schematic block diagram of a SoS unit;

FIG. 4 is a schematic diagram illustrating an example of a sampling data set;

FIG. 5 is a schematic diagram for explaining a feature extraction method;

FIG. 6 is a schematic diagram illustrating an example of a configuration of a complex network;

FIG. 7 is a schematic diagram illustrating an example of a configuration of a complex network;

FIG. 8 is a schematic diagram illustrating an example of a storage battery system and a complex network;

FIG. 9 is a flowchart of information processing by a platform of an embodiment;

FIG. 10 is a schematic block diagram of an analyzer according to Variation 1;

FIG. 11 is a flowchart of information processing according to Variation 1;

FIG. 12 is a schematic block diagram of an analyzer according to Variation 2;

FIG. 13 is a flowchart of information processing according to Variation 2;

FIG. 14 is a schematic diagram illustrating an example of the procedure of quantum-classical hybrid computation;

FIG. 15 is a schematic diagram illustrating an example of a string modeled in one dimension and divided into eight finite elements;

FIG. 16 is a schematic diagram illustrating an example of a quantum circuit corresponding to a matrix;

FIG. 17 is a schematic diagram illustrating an example of a configuration of a quantum circuit for Hadamard test;

FIG. 18 is a schematic diagram illustrating a correspondence between a vibration model of a mechanical system and a vibration model of an electrical system;

FIG. 19 is a schematic diagram illustrating an example of a random network;

FIG. 20 is a schematic diagram illustrating an example of a free-scale network;

FIG. 21 is a schematic diagram illustrating an example of changes in damage probability over time;

FIG. 22 is a schematic diagram illustrating an example of an equivalent circuit model showing current-voltage characteristics; and

FIG. 23 is a hardware configuration diagram of an information processing apparatus.

### DETAILED DESCRIPTION

An information processing apparatus according to an embodiment includes one or more hardware processors. The one or more hardware processors are configured to extract multiple features representing characteristics of pieces of second sampling data. The pieces of second sampling data include pieces of first sampling data and pieces of output data obtained by using the pieces of first sampling data as input. The pieces of first sampling data are generated by using a multidimensional first probability distribution representing a distribution of each of pieces of input data related to an object to be analyzed. The pieces of output data represent physical quantity of the object to be analyzed. The one or more hardware processors are configured to generate a network model representing a relationship among multiple nodes corresponding to the physical quantity of the object to be analyzed. The multiple nodes include a node corresponding to the extracted features.

Exemplary embodiments of an information processing apparatus according to the invention will be described in detail below with reference to the accompanying drawings.

The following describes, as an example, a case where a complex system to be analyzed is an infrastructure system. Examples of the infrastructure system include storage battery systems, wind power plants, power electronics, elevator systems, infrastructure structures, distributed energy plants, power networks, waterworks networks, transportation networks, robot systems, and communication networks. The target system is not limited to the infrastructure system.

As described above, methods for implementing analysis, visualization, and control for appropriate resilience management are needed for the infrastructure system and the like.

Safety-I that is contrasted with Safety-II will be described below. The Safety-I is a concept to improve availability by limiting the occurrence probability of an event in which a system state exceeds a reliability limit to an acceptable level by fully anticipating a safety margin in reliability engineering and risk-based engineering in the related art based on causal analysis and causal relationships.

In contrast, the Safety-II is a new concept to improve system availability (resilience) by allowing the existence of risk scenarios that have not been specified and addressed, and by focusing on normal operation and increasing buffer capacity, tolerance, and flexibility. The Safety-II is not only focused on eliminating things that might go wrong, but also on examining the reasons for things that do go right, and preparing mechanisms to implement a wide variety of measures and adjustments in a timely manner, thereby increasing the possibility of maintaining normal conditions.

The Safety-II recognizes that the complexity of systems is dramatically increasing and a target system is a complex system including nonlinear interaction phenomena, and focuses on the fact that degradation, damage, failures, and problems occurring in an infrastructure system are not avoidable only in measures in the related art of eliminating factors that lead to danger and risk.

Improving availability (resilience management) needs to be understood as a state in which the system operates as well as possible. The goal of efforts to improve availability is not just to prevent the system from operating poorly; rather, the concept is to ensure that the system operates well.

Resilience management (analysis, visualization, and control) for emergent behaviors and phenomena in the complex system is expected to be implemented on the basis of the Safety-II concept. However, specific methodologies utilizing digital twins, for example, have not yet been systematized.

Meanwhile, quantum-classical hybrid computation methods, quantum-inspired calculation methods, and quantum computing methods for a finite element method (FEM) based on variational quantum algorithms have been proposed and confirmed effective. However, specific applications beyond larger and faster computations and specific uses for resilience management have not yet been clarified.

The present embodiment provides a mechanism and a methodology for concretely implementing the Safety-II concept. Specifically, the present embodiment provides a mechanism and a method that can cope with disturbances, changes, and opportunities within a normal range by adjusting and controlling the functions (or modes) of a small number of features by means of the units described later (such as a generation unit for generating sampling data in a multidimensional variable space, an analysis unit for analyzing a complex system phenomenon, and a modeling unit for modeling a complex network including features).

In the related art, risk-based safety management and crisis management efforts have been made to take safety activities on the basis of the concept of probabilistic risk (harm) such as hazard scenario analysis, risk scenario analysis, and resilience analysis. First, problems when a complex system such as an infrastructure system is analyzed will be described. The infrastructure system has complex interactions between parts, units (components or modules), and subsystems. The causes and effect of physical phenomena in the system may not often be sufficiently understood and unpredictable events may occur. Uncertainty, ambiguity, and indeterminacy are inherent in the modeling of the complex system.

Interactions are likely to occur when such states as the following occur.
Correlation of common mode or common cause
Interrelated subsystems
Feedback loop
Indirect information
Multiple related controls
Limited understanding
Limited possibility of isolating failed apparatus
Limited replacement of supply materials

A combination of composite hazards, design defects, apparatus failures, and operator errors may lead to complex interactions. In a complex system, exogenous factors and endogenous factors may cause non-linear phenomena (emergent phenomena and resonance phenomena) such as Bullwhip effect, self-similarity, phase transition phenomena, meta-stability, and unexpected operations, which may lead to a critical phase (crisis).

It has been recognized that the related technology is not able to cope with safety issues related to highly complex social systems. In complex systems, such phenomena as the following may lead to accidents.
Emergent phenomenon in which order emerges in whole or in part from local interactions between elements (temporal and spatial pattern formation)
Chaos or pattern formation (such as dissipative structure) in which complex and disorderly behavior appears from a non-linear but simple and deterministic mechanism
Fat tail where low-frequency events occur more frequently than expected from the law of large numbers, which is the basic theorem of probability statistics

In this way, there is the problem that non-linear interactions between elements constituting a complex system (system elements) and between external loads cause a system to be unstable and a new whole order is formed, which may lead to accidents.

States of the system and system elements are not distinguishable from normal and abnormal, and are constantly varying. This variation is essential for the system and is not stoppable or removable. In a complex technological social system, small variations in the functions of many system elements may cause emergent phenomena and the like, and large functional variations may be induced in the entire system. When such phenomena occur, it is conceivable that multiple safety protection barriers are destroyed, resulting in accidents that exceed expectations.

In order to enhance the resilience of such complex infrastructure systems, there may be multiple measures that are in a desirable state (stable state) (multi-stable state).

In emergent phenomena of complex infrastructure systems, there is a case where a competing mode is present in an initial stage (omen stage), a mainstream mode (critical instability hypothesis) gradually disappears during a transition process, and a stable mode appears in a steady state, and also there is a case where crisis occurs due to an increase in instability. Therefore, before the crisis, it is important to provide a method for finding a sign, selecting data to be monitored in order to ascertain the sign, and reconstructing the infrastructure system so as to prevent an increase in instability.

The concept of new resilience such as Safety-II has been advocated to cope with the above situations. The concept of the new resilience is a concept of extending risk-based safety and crisis management that takes safety activities on the basis of the concept of probabilistic risk. In the concept of the new resilience, it is important to carry out “prediction”, “monitoring”, “response”, and “learning” under an appropriate process approach and a simulation-based system approach based on hypothesis verification, prioritization, and optimization of resilience improvement and measures. However, specific resilience analysis methodologies or frameworks based on the process approach and the system approach have not yet been established.

Resilience analysis that takes interdependence of important infrastructures into consideration is also performed; however, in such resilience analysis, monitoring, physical simulations, chemical simulations, surrogate models, optimization, quantum-inspired calculation, quantum-classical hybrid computation, and quantum computing are not linked. Furthermore, indeterminacy of hazard modes is also large, and hazard scenarios, risk scenarios, and activities scenarios are also carried out within a limited range. Therefore, it is insufficient to perform hypothesis verification, prioritization, and visualization of effects on resilience improvement measures in a complex infrastructure system.

The present embodiment takes measures to improve resilience of an infrastructure such as decentralization, modularization, and reconstruction of an infrastructure system from the viewpoint of complex systems and hierarchical networks of the infrastructure. This makes it possible to increase resilience potential (flexibility and robustness) against disturbances. The present embodiment provides a framework (methodology) for hypothesis verification, prioritization, and visualization of effects of scenarios of measures for improving resilience.

The framework and components of resilience analysis according to the information processing system of the present embodiment are described below. The following description is given on the assumption that the resilience analysis and control include not only a function to analyze and controlling resilience, but also a function to visualize an analysis result, a control method, or a control result on a display apparatus and the like.

In order to efficiently implement resilience analysis of a complex system, at least one of the following points A1 to A3 needs to be considered.
(A1) The number of hazard-related scenarios (hazard scenarios and risk scenarios) and activities scenarios is enormous and it takes a lot of time to prioritize and optimize activities.
(A2) It is often not clear what kind of items need to be monitored to detect abnormal signs of complex systems and improve resilience.
(A3) There is a great deal of indeterminacy in the modeling of hazards that infrastructure systems receive.

The information processing system according to the present embodiment provides a framework for more efficiently implementing resilience analysis of complex systems. The framework enables analysis and management functions to be provided as services. Customers can use services capable of implementing resilience analysis without changing a current customer system.

In the framework, it is desirable that analysis and management services such as industrial Internet of things (IIoT) are defined (published) as application programming interface (API) and API specifications are industry standards such as OpenAPI and web services description language (WSDL). Furthermore, the framework of the present embodiment may have, for example, a function to synchronize time information (trigger) and position information. The position information can be synchronized using, for example, a global positioning system (GPS), a geographic information system (GIS), and a global navigation satellite system (GNSS).

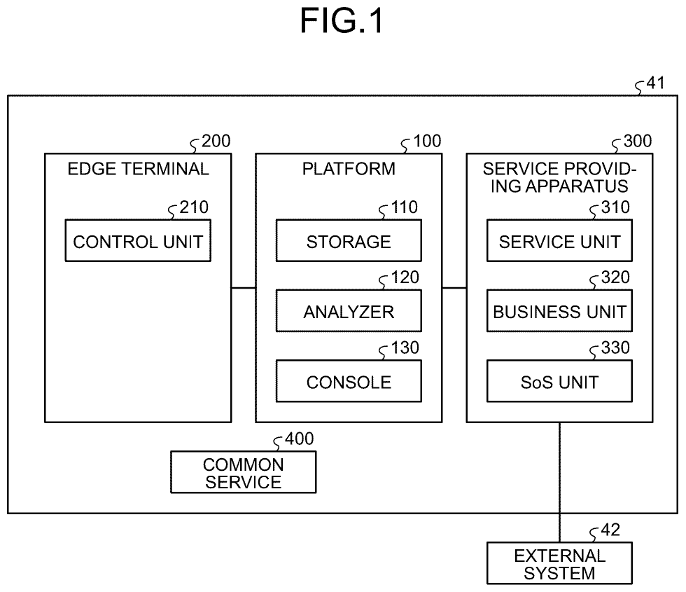

FIG. 1 is a schematic block diagram illustrating an example of the configuration of an information processing system 41 of the present embodiment. As illustrated in FIG. 1, the information processing system 41 includes a platform 100 as an information processing apparatus, an edge terminal 200, a service providing apparatus 300, and a common service 400.

The edge terminal 200 may be implemented by any of the following methods.
Actual sensing and monitoring control terminal
Acquiring unit on a computer, which acquires data such as seismic observation data, meteorological observation data, traffic information, and satellite image data over a network
Virtual edge terminal (data generation unit or data setting unit) that virtually generates sensing and monitoring data on a computer, or sets assumption data by referring to a database, wherein a function of the edge terminal 200 to transmit data (such as a first transmission unit to be described below) may be virtual data transmission on the computer

The edge terminal 200 and the platform 100 are connected by, for example, an interface functioning as an IoT bus. The platform 100 and an enterprise service are connected over, for example, a service bus such as API. The IoT bus and the service bus may be implemented by any method. For example, the IoT bus and the service bus can be implemented by a network (may be any of wired and wireless networks) such as the Internet.

The information processing system 41 may be connected to an external system 42 over, for example, a network such as the Internet. The external system 42 is a system that operates in cooperation with the service providing apparatus 300.

While FIG. 1 illustrates only one edge terminal 200, one platform 100, one service providing apparatus 300, and one external system 42, they may be provided in plural, respectively. It can be interpreted that the entire information processing system 41 corresponds to a cyber physical system (CPS) system. Furthermore, it can be interpreted that the service providing apparatus 300 and the external system 42 correspond to the CPS system, respectively.

The platform 100 may be physically configured by one device, or may be physically configured by two or more devices. For example, the platform 100 may be built on a cloud environment. Each part in the platform 100 may be distributed into the two or more devices.

The edge terminal 200 includes a control unit 210 that controls various processes of the edge terminal 200. For example, the control unit 210 controls the following processes.
Collection of data such as monitoring data
Communication with an external apparatus such as the platform 100 (first transmission unit)
Analysis of data (including analysis of data, or the like)
Conversion of data
Operation control based on control information transmitted from the platform 100 and the like

The control unit 210 controls a function (first transmission unit) to transmit, to the platform 100, monitoring data (measurement data and monitoring data) indicating the state of the target system that is an object to be analyzed (control object).

When no monitoring (measurement and monitoring) is performed, the edge terminal 200 may be included in the platform 100.

The platform 100 includes a storage 110, an analyzer 120, and a console 130. The storage 110 stores data collected by the edge terminal 200 and the like (hereinafter, referred to as monitoring data), and master data. The master data is, for example, data related to specifications of the edge terminal 200, specifications of a usage environment, a design drawing, maintenance history, and the like.

For resilience analysis, the master data includes, for example, configuration data indicating the configuration of a target system, data indicating activities that affect the target system, data indicating actions that affect the target system, and data indicating a hazard model that models hazards (faults) occurring in the target system.

The storage 110 can be formed of any storage media that are commonly used such as a flash memory, a memory card, a random access memory (RAM), a hard disk drive (HDD), and an optical disk. The storage 110 may be implemented by, for example, storages that store monitoring data and master data, respectively. The storages may be physically different storage media or may be implemented as different storage regions of physically the same storage medium.

The analyzer 120 analyzes the monitoring data stored in the storage 110. For example, the analyzer 120 performs resilience analysis using the monitoring data. The function to perform the resilience analysis does not need to be provided in the analyzer 120, and is provided at least in the platform 100.

The console 130 generates control information for controlling the edge terminal 200 on the basis of the analysis result of the analyzer 120, and the like, and transmits the generated control information to the edge terminal 200, thereby operating the edge terminal 200. The control information may be any information as long as it is information for changing the state of the edge terminal 200. For example, the control information is information for causing the edge terminal 200 (the control unit 210) to perform communication, and analysis, state change, sensing, operation instruction, and the like on the edge terminal 200.

At least some of the above units (the analyzer 120 and the console 130) may be implemented by one processing unit. Each of the units is implemented by, for example, one or more processors. For example, each of the units may be implemented by causing the processor, such as a central processing unit (CPU) and a graphics processing unit (GPU), to execute a computer program, namely, implemented by software. Each of the units may be implemented by a processor such as a dedicated integrated circuit (IC), namely, implemented by hardware. Each of the units may be implemented with a combination of software and hardware. When multiple processors are used, each processor may implement one of the units, or may implement two or more of the units.

The control unit 210 of the edge terminal 200 serves to transmit monitoring data to the platform 100, and receive control information from the platform 100. The control unit 210 performs control in the edge terminal 200 on the basis of the control information. On the basis of a changed state of the edge terminal 200, the control unit 210 further transmits monitoring data to the platform 100, and receives control information from the platform 100. By repeating such a loop (CPS loop), a large number of edge terminals 200 are controlled based on the monitoring data accumulated in the platform 100 and an analysis result for the monitoring data.

The service providing apparatus 300 is an apparatus that provides a service using at least one of the monitoring data and the analysis result. The service providing apparatus 300 includes a service unit 310, a business unit 320, and a system of systems (SoS) unit 330.

The service unit 310 is used for a person (administrator) who confirms the monitoring data accumulated in the platform 100 and the analysis result, a person who inspects the state of the CPS loop on the basis of his/her wisdom, a person who manually changes the state of the CPS loop, and the like.

An administrator performs, for example, CPS loop inspection, audit, detection of abnormality occurrence, detection of artificial intelligence (AI) errors (CPS loop abnormality) caused by attacks, and the like on the basis of the knowledge as an expert, and confirms whether the information processing system 41 is properly operating from his/her eyes. When the CPS loop abnormality is perceived, the administrator may troubleshoot the CPS loop by transmitting control information via the service unit 310, or by other methods.

The business unit 320 provides services using the monitoring data and the analysis result. For example, the business unit 320 provides services such as customer relationship management (CRM), enterprise resource planning (ERP), product lifecycle management (PLM), and enterprise asset management (EAM).

The SoS unit 330 includes multiple internal systems and performs cooperation and the like of those internal systems. For example, the SoS unit 330 integrally controls (orchestrates) the CPS loop by using information generated in the service providing apparatus 300, the monitoring data accumulated in the platform 100, and the analysis result.

In a case that multiple service providing apparatuses 300 are provided, the information processing system 41 includes multiple SoS units 330. One service providing apparatus 300 may include the multiple SoS units 330. Each of the SoS units 330 includes multiple internal systems. The SoS units 330 may cooperate with one another via the platform 100, or may cooperate with one another without the platform 100.

Each of the internal systems may be any system as long as it is independently managed and operated. For example, the internal system may be a CPS system or a system that provides services by a cloud server or a multi-access edge computing (MEC) server. The internal system may be a system that provides a service corresponding to the business unit 320.

The internal system receives information and requests from the edge terminal 200 and the like, and returns information corresponding to the received information and requests. The internal system may accumulate information received from the edge terminal 200 and the like, and construct information (digital twin) that reproduces the real world on a cyber world.

The SoS unit 330 exchanges information with the distributed internal systems and provides a function that is not implementable by a single system. For example, in principle, each of the internal systems performs control for optimization (partial optimization) in a controllable region therein. In contrast, the SoS unit 330 integrally controls the internal systems, and performs control for optimization (overall optimization) in all the internal systems integrally controlled. The SoS unit 330 is not limited thereto and for example, may be a system that provides a function different from the function of each of the internal systems.

Each of the internal systems may be a system related to a single industrial field (service). The SoS unit 330, for example, integrally controls internal systems belonging to different industrial fields.

Regarding resilience analysis, the SoS unit 330 is used for confirming a result of resilience analysis targeting a complex system by the internal systems integrally controlled, specifying analysis conditions (such as configuration data, actions, and hazard models) for the resilience analysis, implementing measures based on the result of the resilience analysis, and the like.

At least some of the units (the service unit 310, the business unit 320, and the SoS unit 330) may be implemented by one processing unit. Each of the units is implemented by, for example, one or more processors. For example, each of the units may be implemented by causing the processor such as a CPU and a GPU to execute a computer program, namely, implemented by software. Each of the units may be implemented by a processor such as a dedicated IC, namely, implemented by hardware. Each of the units may be implemented with a combination of software and hardware. When multiple processors are used, each processor may implement one of the units, or may implement two or more of the units.

The common service 400 is an apparatus that provides services that are commonly available to the respective units (the edge terminal 200, the platform 100, and the service providing apparatus 300) in the information processing system 41. The common service 400 provides, for example, the following functions.
Security function
Logging function
Charging function

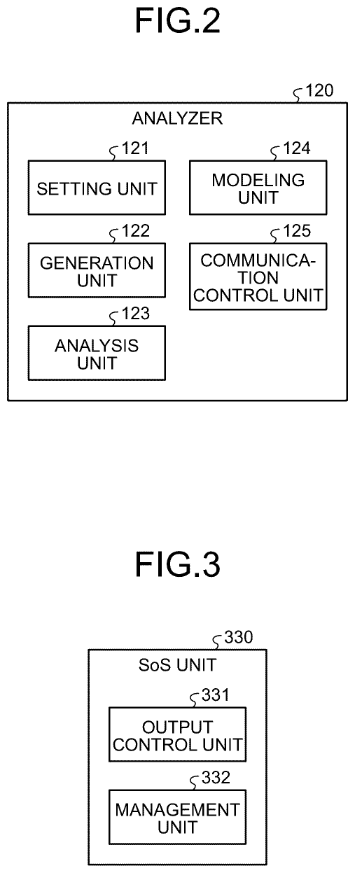

The following describes details of the functions of the analyzer 120 of the platform 100. FIG. 2 is a schematic block diagram illustrating an example of the functional configuration of the analyzer 120. As illustrated in FIG. 2, the analyzer 120 includes a setting unit 121, a generation unit 122 (an example of a generation circuit), an analysis unit 123 (an example of an analysis circuit), a modeling unit 124 (an example of a modeling circuit), and a communication control unit 125.

The setting unit 121 serves to make various settings for resilience analysis. For example, the setting unit 121 sets up scenarios about the target system. The setting unit 121 may make these settings according to a designation from the service providing apparatus 300 (the SoS unit 330). When the target system is reconstructed, the setting unit 121 sets configuration data of the reconstructed target system.

The following describes the scenario. Analysis, visualization, and control for juxtaposing various values such as resilience management and circular economy of the target system being a complex system are performed after setting up the scenario.

The scenario is an actual use case (instance) and represents a specific procedure when the use case is executed. Each use case is expressed as a set of scenarios, from which necessary classes and objects are extracted. The movement of the target system can be specifically expressed through scenarios and actual use cases. The scenario includes a large number of variables, and random variables following a probability model when a definite value exists. Therefore, the scenario is represented by multivariate probability distributions. A multivariate probability distribution for a variable X=(x, y), including a variable x for the input of the target system and a response variable y of the target system, exists for each scenario.

The scenario can be expressed, for example, by a sequence diagram, a class diagram, a collaboration diagram, a statechart diagram, or the like. These can be used for obtaining a multivariate probability distribution (multivariate probability distribution model or multivariate probability model).

The use case represents how the target system needs to function and an external environment (actors) of the target system, and can indicate the behavior of the target system. The use case can clarify the boundaries between the outside and inside of the target system, as well as customer requirements. An actor represents a role played by a user of the target system, rather than a part of the target system. The actor actively exchanges information with the target system or passively receives information from the target system. Humans, hardware, and external systems can be actors.

The use case models an interaction between the actor and the target system, and includes event flows. The use case is initiated by the actor and performs some functions of the target system. The use case is an abstraction of one of unit operations that a user of the target system performs using the target system. By collecting all the use cases, the ways of using the target system are all represented.

The object is also called an instances, actually exist in the real world, and has state, behavior, and identifiability. The state of the object specifies one situation that the object can take. The behavior indicates how the object acts or reacts to requests from other objects. Each object has identifiability (identity), and needs to be identified as something different even though the state of the object is identical to the state of another object.

The class is an abstract definition of a set of objects with a common structure and a common behavior. The class can be described in three regions as follows.
First region: class name
Second region: structure (set of attributes)
Third region: behavior (set of operations)

Each of scenarios that can be set in the present embodiment is represented by a multivariate probability distribution for the variable x=(x, y) as described above. The variable x corresponds to pieces of input data related to the target system, and is for example, a variable related to analysis conditions such as load, structure, material properties, boundary conditions, and environmental conditions. Each scenario may include m (m is an integer equal to or greater than 1) analysis conditions, namely, m variables x. Setting up the scenario includes some or all of setting up the type of analysis conditions (variable x) and setting up the probability distribution of the analysis conditions. In the following, a multidimensional probability distribution (multivariate probability distribution) representing the distribution of each variable x (also referred to as analysis condition x) may be referred to as a probability distribution PA (first probability distribution).

The generation unit 122 generates pieces of multidimensional sampling data SDA (an example of the first sampling data) by using the probability distribution PA. In one example, the generation unit 122 samples the value of each variable x according to the probability indicated by the probability distribution PA, and generates sampling data SDA including the sampled values of the variables x. Although any method of generating the sampling data by using the probability distribution PA can be used, for example, a sampling method using the following calculations can be applied.
Quantum-inspired calculation
Quantum Computing calculation
Lagrangian Monte Carlo calculation
Hamiltonian Monte Carlo calculation
Markov chain Monte Carlo calculation

The generation unit 122 generates sampling data in a variable space for variables related to the analysis conditions within the multidimensional variable space. The multidimensional variable space means a variable space related to analysis conditions and responses to the analysis conditions. Within the multidimensional variable space, sampling data in the variable space related to the responses is generated by the analysis unit 123.

The generation unit 122 may further calculate the occurrence probability of emergent phenomena (including rare events) in the complex system. The occurrence probability represents, for example, the ratio of the number of sampling data SDA, for which the corresponding response variable y (output data) satisfies a specific condition, to the number of the pieces of generated sampling data SDA. The specific condition is, for example, a condition in which the response variable y exceeds predetermined criteria. The criteria are represented by a threshold for the occurrence of an emergent phenomenon, or a curved surface, a function, or the like, representing criteria in the multidimensional variable space. The occurrence probability can be used for controlling the target system, for example.

The analysis unit 123 performs an analysis process of obtaining the response variable y of the target system by using the sampling data SDA. For example, the analysis unit 123 takes the pieces of sampling data SDA generated by the generation unit 122 as input data, and obtains pieces of output data (response variable y) representing the physical quantity of the target system. Obtaining the response variable y corresponds to generating sampling data in a variable space for a response.

In the following, the sampling data in the multidimensional variable space, including the sampling data of the variable x related to the analysis conditions and the sampling data of the response variable y, is referred to as sampling data SDB (an example of the second sampling data). In the following, pieces of sampling data SDB may be referred to as a sampling data set.

The analysis unit 123 performs the analysis process by using, for example, the following method. Details of the analysis process by the analysis unit 123 will be described in detail below.
Phenomenon analysis using quantum-classical hybrid calculation
Phenomenon analysis using quantum-inspired calculation
Phenomenon analysis using quantum computing
Phenomenon analysis using surrogate model

The modeling unit 124 generates a network model (hereinafter, referred to as a complex network) of the complex system corresponding to the target system by using the sampling data set. The complex network is, for example, a network model representing relationships among multiple nodes corresponding to the sampling data set.

For example, the modeling unit 124 first extracts multiple features representing the characteristics of the sampling data set. The modeling unit 124 generates a complex network representing relationships among multiple nodes including a node corresponding to the extracted features. Details of the model generation process of the modeling unit 124 will be described below.

The functions of the generation unit 122, the analysis unit 123, and the modeling unit 124 can generate a complex network including the features of a complex system phenomenon. The generated complex network can be used for controlling the target system, for example. For example, by controlling the extracted features as control variables, a target system including many variables can be controlled to normally operate with only a few features. In this way, in the present embodiment, even when a plurality of phenomena are interdependent, a plurality of responses can be kept within a desirable range by unraveling the interdependence of the plurality of responses and then adjusting features. The present embodiment may be configured to control some variables by using the feature as an index. For example, the present embodiment may be configured to specify variables that strongly affect the features and control the specified variables.

The communication control unit 125 serves to control communication with an external apparatus such as the service providing apparatus 300. For example, the communication control unit 125 transmits information indicating the analysis result of the analysis process to the external apparatus such as the service providing apparatus 300.

The following describes details of the functions of the SoS unit 330 of the service providing apparatus 300. FIG. 3 is a schematic block diagram illustrating an example of the functional configuration of the SoS unit 330. As illustrated in FIG. 3, the SoS unit 330 includes an output control unit 331 and a management unit 332.

The output control unit 331 serves to control output of various kinds of data processed by the service providing apparatus 300. For example, on the basis of the analysis result of the resilience analysis, the output control unit 331 outputs information obtained by visualizing the analysis result. A method for outputting the information may be any method, but for example, a method for displaying the information on a display, a method for transmitting the information to an external apparatus connected over a network, and the like can be applied.

The management unit 332 serves to manage a complex system according to the analysis result of the resilience analysis. For example, the management unit 332 manages the implementation of measures determined from the analysis result. As described above, the measures are reconstruction and the like of complex system networks.

The following describes details of the model generation process by the modeling unit 124.

The modeling unit 124 first extracts a sampling data set from the sampling data set in the multidimensional variable space according to configuration information. The configuration information includes, for example, the following information.
Target region to be analyzed in complex system
Phenomenon response (response variable y) of target region
Scenario or analysis condition
Number of sampling data

The target region represents a region including a node to be analyzed among components (hereinafter, also referred to as nodes) included in the target system.

The modeling unit 124 performs modeling (hereinafter, referred to as complex network modeling) of a complex network including features by using the extracted sampling data set as input.

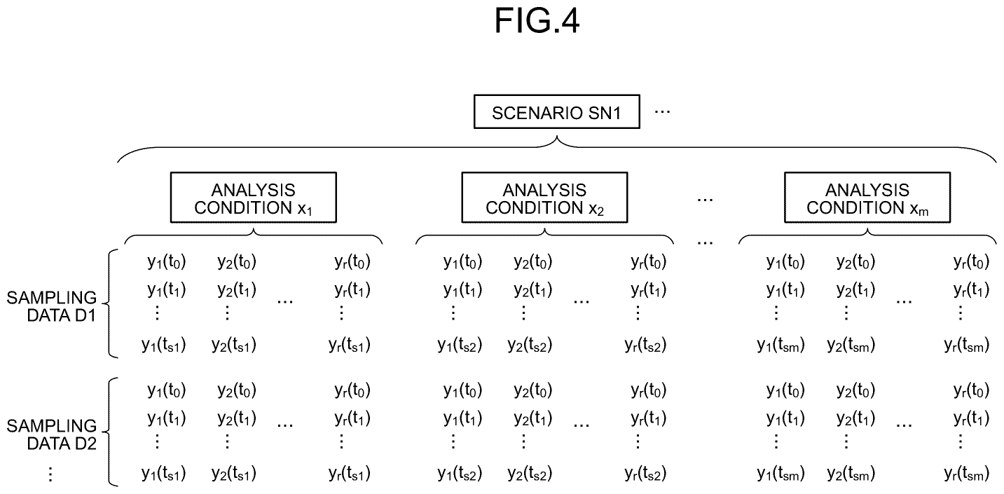

FIG. 4 is a schematic diagram illustrating an example of a sampling data set to be input to modeling. A scenario SN1 corresponds to a scenario set by configuration information, for example. The scenario SN1 in FIG. 4 includes m analysis conditions x₁ to xₘ. Accordingly, setting the scenario SN1 can be interpreted as equivalent to setting the analysis conditions x₁ to xₘ. Each of the analysis conditions xᵢ (i is an integer satisfying 1≤i≤m) is correlated with a parameter representing a multivariate probability distribution (such as a probability model parameter for x in a multivariate probability model).

In FIG. 4, response variables y₁(t) to yᵣ(t) representing phenomenon responses at all nodes (r nodes) included in the target system are listed, and among the response variables y₁(t) to yᵣ(t), the response variable y set by the configuration information is extracted as response variable data to be included in the sampling data set. For example, as the phenomenon response of the target region, a phenomenon response relative to a node being main or representative (referred to as representative node) among the r nodes is set. Note that t (such as t₀ to tₛ₁) denotes the time when sampling data has been sampled. Sampling data of the preset number are extracted from among the pieces of sampling data including sampling data D1 and D2.

In this way, the sampling data set is a data set of temporal and spatial physical quantities related to the phenomenon response of a complex system to various scenarios and analysis conditions. The node's phenomenon response (response variable y) is, for example, a variable vector (such as current, temperature, or load) or a tensor (such as stress), each formed by physical quantities.

For example, the scenario may be set in the following manner.
Whether to include, as hazards, probability models (analysis conditions) for events that rarely occur such as strong winds and large-scale earthquakes, in addition to normal operational loads
Whether to include probability models of degradation events, such as degradation of system cooling performance, as degradation scenarios
Whether to include a probability model of when to replace parts as a maintenance condition

The configuration information for extracting the sampling data set to be input to the complex network modeling is, for example, preconfigured. The target region for analysis (phenomenon response of the target region) may be set by relationship analysis, causal and correlation analysis, typification, classification, clustering, hierarchization, and ranking methods (See, for example, A Comprehensive Survey of Graph Embedding: Problems, Techniques and Applications, arXiv: 1709.07604) that use AI such as a graph neural network (GNN), machine learning, a probabilistic method, and a statistical method.

The following describes an example of the procedure for extracting physical quantity corresponding to representative nodes from a sampling data set (data set of temporal and spatial physical quantities related to a phenomenon response).

First, a set of analysis conditions to be covered and a range of sampling data to be covered, namely, a range in a data set of (x, y) is set. The modeling unit 124 analyzes a causal correlation structure from the physical quantity data set of all nodes included in the set range while performing spatial or temporal typification (clustering) or hierarchization, and extracts, as representative nodes, a node with large change in response, a node with large relevance, etc.

The following models and algorithms, for example, can be utilized to analyze the causal correlation structure.
Machine learning algorithms such as graph neural networks
Statistical probability models such as Bayesian and Markov models

When representative physical quantities suitable for predicting and controlling a phenomenon are known in advance, the modeling unit 124 may extract representative nodes based on previously obtained information (configuration information).

The modeling unit 124 may generate a sampling data set to be input to complex network modeling by using the extracted representative nodes. For example, the modeling unit 124 extracts physical quantities of the representative nodes from a small number of sampling data sets. The modeling unit 124 generates a large number of sampling data sets for the extracted physical quantities of the representative nodes by using the generation unit 122 and the analysis unit 123. The modeling unit 124 uses the sampling data set generated in this way as input to the complex network modeling.

In one example, after selecting, from a small number of sampling data sets (for example, 1000 samplings), a data set on physical quantities of representative nodes that can represent the characteristics of a phenomenon, the modeling unit 124 generates a large amount of sampling data (for example, 1 million samplings) for the representative nodes and use the generated sampling data as input for the complex network modeling. The following describes details of the complex network modeling. The modeling unit 124 generates a complex network including features such that a multivariate probability distribution of an input sampling data set is consistent with a multivariate probability distribution generated from the features.

In one example, the modeling unit 124 extracts multiple features (feature vectors and latent variable vectors) representing the characteristics of the sampling data set. Any method of feature vector extraction may be used, for example, methods using generative AI algorithms such as variational auto-encoder Bayes (VAE) and flow-based generative models can be applied.

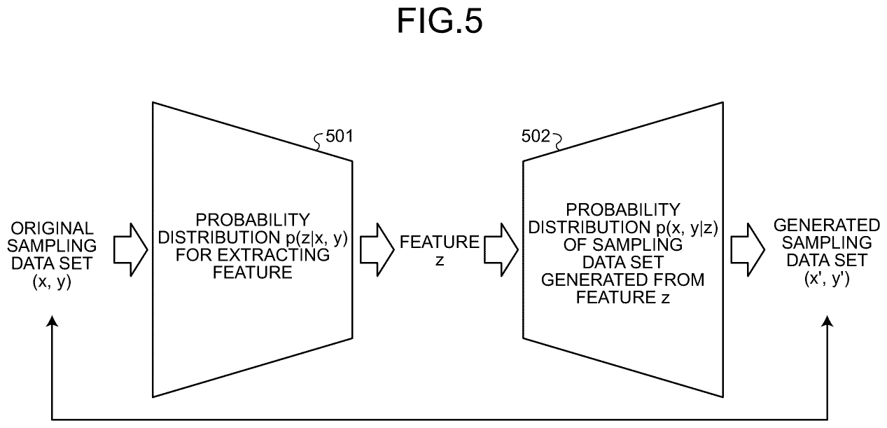

FIG. 5 is a schematic diagram for explaining an example of a feature (feature vector z) extraction method. The modeling unit 124 inputs a sampling data set (x, y) to an encoder 501 to obtain a feature z to be output. The encoder 501 is represented by a probability distribution p (z|x, y). The modeling unit 124 inputs the feature z to a decoder 502 to obtain a sampling data set (x′, y′) to be output. The decoder 502 is represented by a probability distribution p (x, y|z).

At this time, the modeling unit 124 extracts the feature vector z such that a probability distribution of the sampling data set (x′, y′) generated from the feature vector z is consistent with a multivariate probability distribution p (x, y) of the input original sampling data set (x, y).

Specifically, the modeling unit 124 generates a sampling data set including pieces of sampling data (third sampling data) on the basis of the feature vector z, and extracts a feature vector to optimize an index indicating whether a multidimensional probability distribution (second probability distribution) representing a distribution of the sampling data set is consistent with the multivariate probability distribution p (x, y).

The modeling unit 124 may sequentially increase the number of elements in the feature vector z until the probability distributions is consistent with each other, but control is often easier when the number of elements is as small as possible.

The modeling unit 124 generates a complex network representing the relationships among multiple nodes including a node corresponding to the extracted feature (feature vector z). Any method of generating a network model (complex network) may be applied, for example, a method of generating a network model having the following form can be applied.
Node-link (also called edge) model (also including strength of link correlation)
AI Model
Machine Learning Model
Statistical Probability Model

The complex network may be a network that changes over time.

In the present embodiment, the complex network can be interpreted as corresponding to a network model for representing transfer paths, relationships, or pattern formations of physical quantities (such as force, heat, current, voltage, and order variables) related to a complex system phenomenon. The complex network of the present embodiment is a network model including features governing a complex system phenomenon.

For example, when a differential equation expressing a complex system phenomenon is analyzed by a numerical analysis method based on a finite element method, each finite element, each node, and each integration point can be a node. The phenomenon response of a complex system also includes the physical quantities of each element, the physical quantities of each node, and the physical quantities of each integration point. The phenomenon response may be represented by any one of physical quantity, scalar (such as temperature and charge), vector (such as load, displacement, and current), and tensor (such as stress).

The interaction of physical quantities at each node can be calculated by correlation analysis from data indicating temporal and spatial changes. A complex network (node-link model) between elements (nodes) can be generated by connecting links with a correlation equal to or greater than a given value. The frequency (number of links) of one node can also be calculated. For example, nodes where physical quantities are concentrated have a large degree, and nodes (concentrated parts) that are affected not only by local causes but also by global influences have a larger degree.

Complex networks can also be typified (cluster classification) as sub-networks or hierarchized at each concentration part, depending on community identification, classification methods, or the like.

The modeling unit 124 may have a function to calculate an index related to a complex network. The index can be used, for example, for management using the complex network. The index indicates the characteristics and lawfulness (such as robustness to disturbances and flexibility to reconfiguration, scalability) of the complex network with links between nodes. The followings are examples of index for calculating the complex network (see, for example, A Comprehensive Survey on Graph Neural Networks, arXiv: 1901.00596).
Extraction of order and control variables for pattern formation in complex systems
Calculation of performance degradation, deterioration, damage, and failure probability
Scale-free index
Dynamic capability (such as robustness to disturbances and ease of reconfiguration or rebuilding)

The modeling unit 124 may further have the following functions
Function to calculate the probability distribution of a criteria function (curved surface in a multivariable space with a phenomenon response as a variable) for cumulative damage, deterioration, abnormality occurrence, or the like in life prediction by utilizing a part of generated sampling data
Function to calculate the occurrence probability of damage, deterioration, and abnormality occurrence by using the above probability distribution

The calculated occurrence probability (including the occurrence probability of rare events) can be used as an index for resilience management such as extending lifespan.

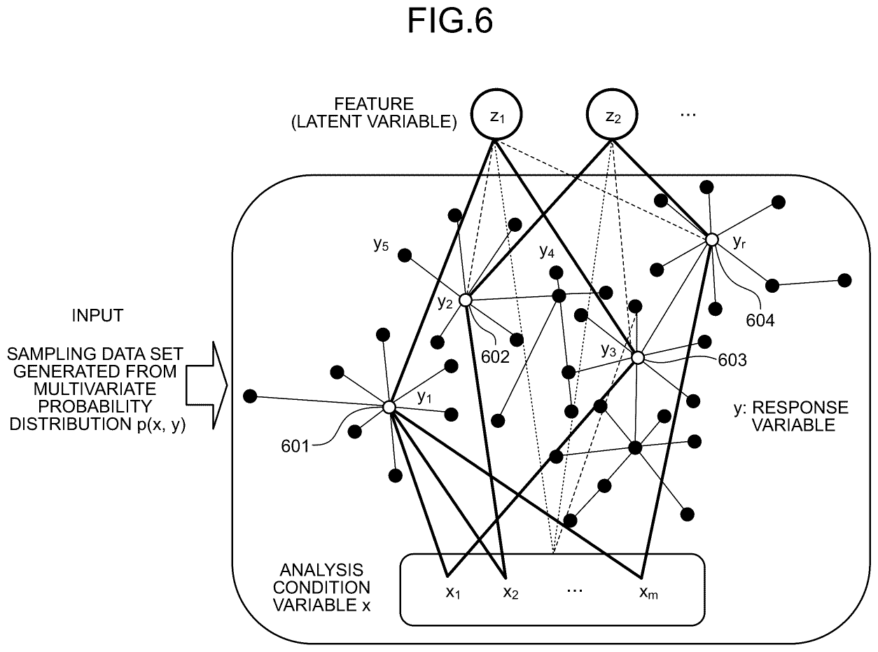

FIG. 6 is a schematic diagram illustrating an example of a configuration of a complex network generated (modeled) by the modeling unit 124. As illustrated in FIG. 6, the complex network includes nodes corresponding to plural response variables y included in input sampling data and links (lines connecting multiple nodes) indicating the relationships among the nodes. Among the multiple nodes, nodes 601 to 604 are nodes connected to a larger number of other nodes and correspond, for example, to nodes where physical quantities are concentrated. In the example in FIG. 6, the nodes 601 to 604 correspond to response variables y₁, y₂, y₃, and yᵣ, respectively.

The complex network also represents the relationship between a feature z, which is extracted from a sampling data set (x, y) related to a variable x corresponding to an analysis condition and a response variable y, and the response variable y. In FIG. 6, for example, the node 601 (response variable y₁) is related to variables x₁, x₂, xₘ, and feature z₁.

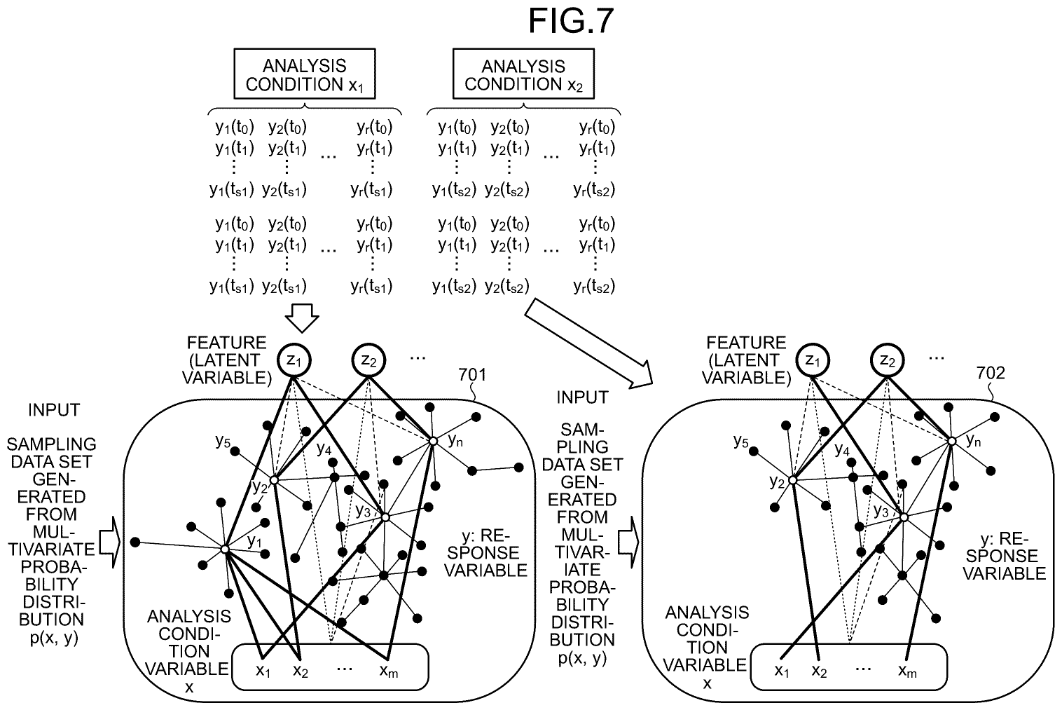

FIG. 7 is a schematic diagram illustrating an example of a configuration of a complex network generated on the basis of typification of sampling data sets. FIG. 7 illustrates an example of typifying a sampling data set according to analysis conditions x₁ and x₂.

For example, for the analysis condition x₁, a response variable y at a representative node is selected from the sampling data set corresponding to the analysis condition x₁ by typification using a graph neural network, and a complex network 701 including nodes corresponding to the selected response variable y is generated.

Similarly, for the analysis condition x₂, the response variable y at the representative node is selected from the sampling data set corresponding to the analysis condition x₂ by typification using the graph neural network, and a complex network 702 including nodes corresponding to the selected response variable y is generated.

The following describes specific examples of a complex network that is generated. The following describes an example in which the target system is a storage battery system. The case of controlling complex system phenomena (electrical circuit of charging and discharging phenomena and thermal circuit network phenomena of heating and cooling) in the storage battery system will be described.

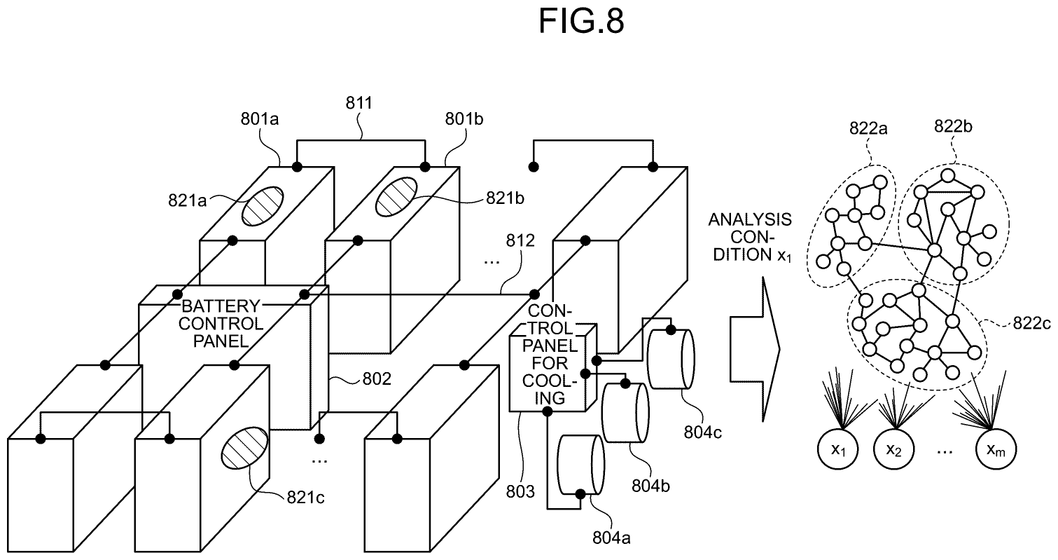

FIG. 8 is a schematic diagram illustrating an example of a configuration of the storage battery system and an example of a complex network generated for the storage battery system. As illustrated in FIG. 8, the storage battery system includes storage battery modules (such as storage battery modules 801a and 801b), a battery control panel 802, a control panel 803 for cooling, and air cooling fans 804a to 804c.

The storage battery modules are electrically connected to each other by connecting wires 811 or the like. The storage battery modules are electrically connected to the battery control panel 802 by connecting wires 812. Each storage battery module includes a number of battery cells. The cells are also connected in series and parallel. Each cell generates heat as current flows through each cell due to charging and discharging. Therefore, the current and temperature of the cells have a temporal and spatial distribution within the storage battery module and the storage battery system. The degree of degradation of each cell also differs depending on charge/discharge waveforms and temperature distributions.

The temperature distribution also depends on the cooling performance and environment within the storage battery system. When analyzing the phenomena of charging and discharging behavior and temperature distribution for all cells in the storage battery system, current, voltage, temperature, and the like at each node (each node or each element) discretized for numerical analysis of differential equations describing phenomena in each cell and each storage battery module are physical quantities representing states.

Rather than performing complex network modeling with the physical quantities of all the nodes as response variables, performing complex network modeling after extracting the physical quantities of representative nodes suitable for predicting and controlling phenomena is more efficient.

For example, as illustrated in FIG. 8, when temperature irregularities 821a to 821c occur in each storage battery module in the storage battery system, only the physical quantities of nodes, where temperature irregularities occur and cell degradation risk is a concern, and the physical quantities correlated with the nodes are extracted for complex network modeling as response variables. Regions 822a to 822c in the complex network illustrated on the right side of FIG. 8 correspond to regions (groups of nodes in the complex network) including nodes corresponding to response variables corresponding to the temperature irregularities 821a to 821c. The response variables corresponding to the nodes are, for example, temperature, current, voltage, and the like. Analysis conditions x₁ to xₘ are connected by links to nodes corresponding to relevant response variables.

The following describes the procedure for extracting representative nodes in the storage battery system. The following scenario and analysis conditions are set up to describe an example in which three temperature irregularity regions occur during operation of the storage battery system.
Scenario: Cooling method is air-cooled fan cooling
Analysis Condition: charging/discharging waveform pattern condition, environmental temperature condition, and system configuration condition are the analysis condition x₁ expressed in a multivariable probability model

First, the modeling unit 124 generates a complex network including no feature z for each target analysis condition by using typification and causal correlation analysis methods, such as graph neural networks, on sampling data for the analysis condition x₁.

The modeling unit 124 extracts, from the obtained complex network, representative nodes that can represent the characteristics of a phenomenon, by using, as an index, the strength of the relationship between the nodes above a default value, or the magnitude (such as absolute value and variation range) of the physical quantity of each node.

When the complex network is typified as illustrated on the right side of FIG. 8 (clustered into the three regions 822a to 822c), the modeling unit 124 may extract representative nodes for each region. The modeling unit 124 may also generate a complex network partly including a hierarchical network that is newly expressed with a representative node by which multiple nodes are integrated.

The modeling unit 124 selects responses with strong relevance by means of typification and correlation analysis using graph neural networks or the like. In one example, only responses related to representative nodes of a complex network (for example, response variables y₂, y₅, and y₁₀) are selected. Such a process is performed for each analysis condition of each scenario in the set scenarios and analysis conditions, and the selected sampling data sets are collected as input data for complex network modeling including features.

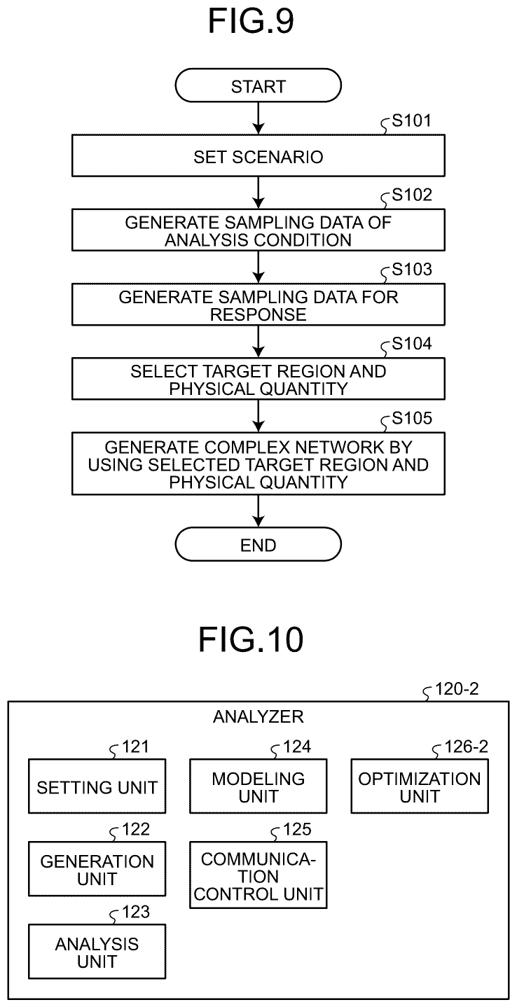

The following describes information processing by the platform 100. FIG. 9 is a flowchart showing an example of information processing by the platform 100 of the present embodiment.

The setting unit 121 sets a scenario in response to a specification from, for example, a user, the service providing apparatus 300 (SoS unit 330), or the like (step S101). The generation unit 122 generates pieces of sampling data SDA corresponding to sampling data of analysis conditions by using a probability distribution PA corresponding to the set scenario (step S102). The analysis unit 123 generates sampling data for a response (response variable y) through an analysis process using the pieces of sampling data SDA (step S103).

The modeling unit 124 selects a target region and physical quantity (phenomenon response) of the target region by using a data set (sampling data set) of sampling data SDB including the sampling data SDA of analysis conditions and the sampling data for a response (step S104). The modeling unit 124 generates a complex network by using the selected target region and physical quantity (step S105), and ends the information processing.

### Variation 1

In the present variation, the generation of a complex network is repeated while modifying a scenario until a generated complex network satisfies predetermined requirements.

In the present variation, the function of the analysis unit differs from the above embodiment. FIG. 10 is a schematic block diagram illustrating an example of a functional configuration of an analyzer 120-2 according to Variation 1. As illustrated in FIG. 10, the analyzer 120-2 includes the setting unit 121, the generation unit 122, the analysis unit 123, the modeling unit 124, the communication control unit 125, and an optimization unit 126-2.

The analyzer 120-2 differs from the analyzer 120 of the above embodiment in that the optimization unit 126-2 is further provided.

The optimization unit 126-2 modifies a scenario to optimize the index of a network model generated by the modeling unit 124. Modifying the scenario is equivalent to modifying a multivariate probability distribution (probability distribution PA) indicated by the scenario. As described above, setting up a scenario also includes setting up the type of analysis conditions. The analysis conditions may also include system configuration conditions. Accordingly, modifying the scenario includes, for example, modifying a system configuration.

The generation unit 122 generates pieces of sampling data SDA by using the modified probability distribution PA. The subsequent functions of the analysis unit 123 and the like are the same as in the above embodiment.

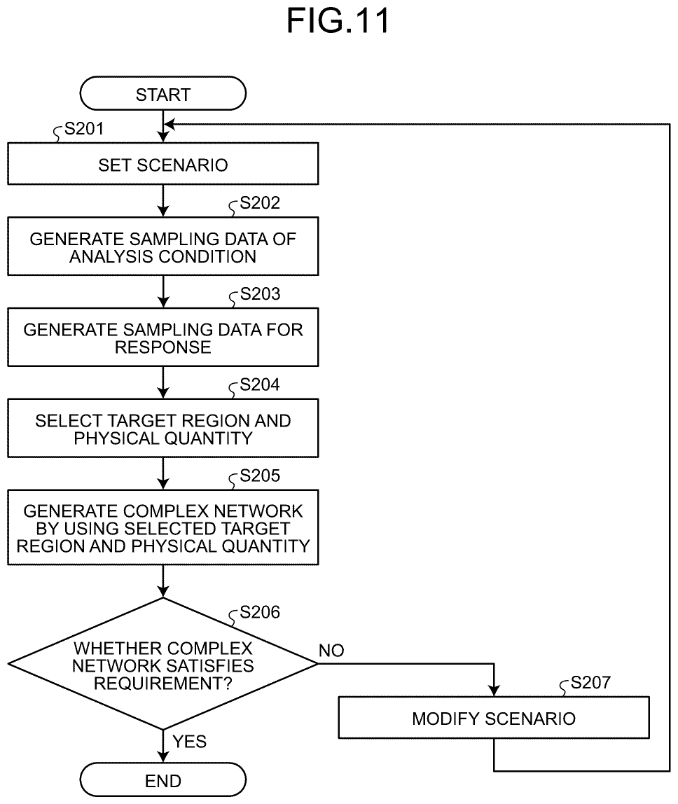

FIG. 11 is a flowchart illustrating an example of information processing in the present variation. Since steps S201 to S205 are the same as steps S101 to S105 in FIG. 9 illustrating the information processing of the above embodiment, descriptions thereof are omitted.

In the present variation, the optimization unit 126-2 determines whether the generated complex network satisfies the requirements (step S206). The determination on whether the requirements are satisfied may be performed in the following manner.
When features can be extracted, the requirements are determined to be satisfied
When a calculation index such as a scale-free index satisfies a standard value, the requirements are determined to be satisfied
When the multivariate probability distribution of the sampling data set is consistent with the multivariate probability distribution generated from the features extracted during complex network modeling, the requirements are determined to be satisfied

When the complex network do not satisfy the requirements (No at step S206), the optimization unit 126-2 modifies the scenario (step S207). Subsequently, the procedure returns to step S201, the modified scenario is set and the procedure is repeated. When the complex network satisfies the requirements (Yes at step S206), the information processing ends.

### Variation 2

The present variation is an example including a function to control the target system by using a generated complex network and a function to update a multivariate probability distribution by using monitoring data.

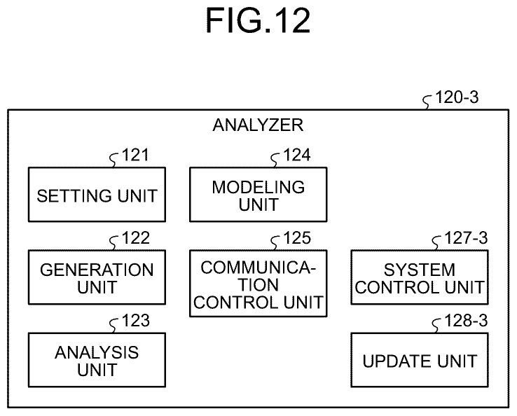

In the present variation, the function of the analysis unit differs from the above embodiment. FIG. 12 is a schematic block diagram illustrating an example of a functional configuration of an analyzer 120-3 according to Variation 2. As illustrated in FIG. 12, the analyzer 120-3 includes the setting unit 121, the generation unit 122, the analysis unit 123, the modeling unit 124, the communication control unit 125, a system control unit 127-3, and an update unit 128-3.

The analyzer 120-3 differs from the analyzer 120 of the above embodiment in that the system control unit 127-3 and the update unit 128-3 are further provided.

The system control unit 127-3 controls one or more responses of the complex system by adjusting the values of the features extracted in the complex network modeling. For example, the system control unit 127-3 controls the target system by using multiple features as control variables.

When the occurrence probability of emergent phenomena (including rare events) is calculated by the generation unit 122 or the like, the system control unit 127-3 may control the target system such that the occurrence probability reaches a target value.

The update unit 128-3 updates the multivariate probability distribution (such as probability distribution PA) by using monitoring data measured from the target system. For example, when monitoring data of phenomena related to the target system is present, the update unit 128-3 identifies variables corresponding to the monitoring data among multivariables by inverse analysis and updates a preset probability distribution to a posterior distribution for the identified variables. The monitoring data needs not be actually measured data, and may be, for example, sampling data generated by simulation.

The function to control the target system by using the generated complex network (system control unit 127-3) and the function to update the multivariate probability distribution by using the monitoring data (update unit 128-3) can be performed independently. Accordingly, the analyzer 120-3 may include any one of the system control unit 127-3 and the update unit 128-3.

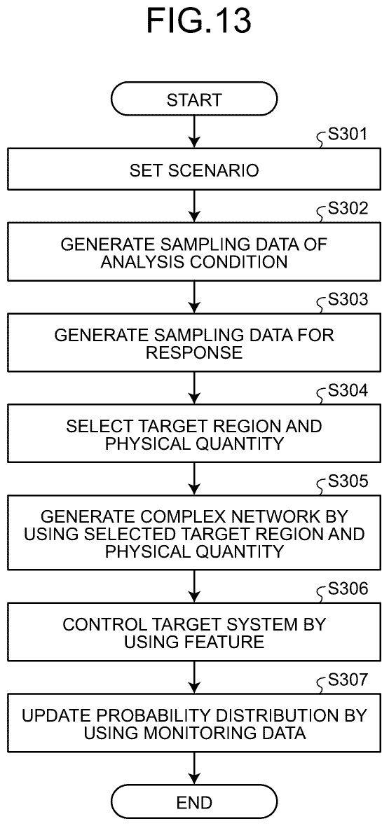

FIG. 13 is a flowchart illustrating an example of information processing in the present variation. Since steps S301 to S305 are the same as steps S101 to S105 in FIG. 9 illustrating the information processing of the above embodiment, descriptions thereof are omitted.

In the present variation, the system control unit 127-3 controls the target system by using the features in the generated complex network as control variables (step S306).

The update unit 128-3 updates the probability distribution to, for example, a posterior distribution by using the monitoring data (step S307).

The following describes details of the analysis process by the analysis unit 123. First, the following describes an example of the configuration of the analysis unit 123 in the case of performing phenomenon analysis by quantum-classical hybrid computation.

In this case, the analysis unit 123 is configured to have the following two main functions.
(F1) Variational quantum algorithm
(F2) Optimization algorithm (based on classical computation)

In one example, the analysis unit 123 performs a quantum operation including an operation of decomposing a matrix based on a Hamiltonian generated from pieces of multidimensional sampling data SDA generated by the generation unit 122 (the function F1 above), and obtains pieces of output data through an optimization process on the results of the quantum operation (the function F2).

The following describes the two functions noted above. In the function F1, the analysis unit 123 generates a phenomenon analysis model including a mesh model (FEM mesh) by a numerical calculation method for differential equations such as a finite element method, by using analysis conditions (such as load, structure, material properties, boundary conditions, and environmental conditions). The phenomenon analysis model is, for example, a model for receiving a variable x corresponding to the analysis condition and outputting a phenomenon response (response variable y). The analysis unit 123 generates a Hamiltonian and a matrix form of the Hamiltonian for quantum-classical hybrid computation by using the phenomenon analysis model (Hamiltonian/matrix form generation unit). In general, physical quantities such as the Hamiltonian can be expressed in matrix form.

In the case of a phenomenon expressed in continuum mechanics, the analysis unit 123 generates a phenomenon analysis model that outputs an energy functional, by means of a method disclosed in, for example, a patent document: Japanese Patent Application Laid-open No. 2022-049067. The energy functional φ_{E} is calculated by summing the energy functional φ_{Ee} for each FEM element expressed by equation (1) below with respect to all FEM elements as shown in equation (2).

$${∅}_{Ee} = ELASTIC ENERGY + {\int }_{V} {\int }_{0}^{\dot{ε}} \overline{σ} d \overline{\dot{ε}} dV - {\int }_{{S}_{t}} {F}^{T} \cdot \dot{u} dS \qquad ( 1 )$$

$${∅}_{E} = {\sum }_{ALL ELEMENTS} {∅}_{Ee} \qquad ( 2 )$$

Note that u is displacement, σ is equivalent stress, ε is equivalent strain, F is an external force vector acting on the boundary, V is the volume of an object, and S is a surface area. The second term corresponds to the integral of the equivalent stress and the incremental equivalent strain rate. The third term corresponds to the work that an object does with respect to an external force (product of the external force vector and the rate).

The analysis unit 123 calculates a Lagrangian from the energy functional and generates a Hamiltonian by performing a Legendre transformation on the Lagrangian. The method of generating the Hamiltonian is not limited thereto and any other method may be used.

The analysis unit 123 can also generate Hamiltonian matrix forms (stiffness matrix, displacement vector, and load vector) by expressing differential equations describing phenomena in weak form using the finite element and Galerkin methods.

Equations (3) and (4) below indicate examples of the matrix forms generated. K denotes a stiffness matrix, M denotes a mass matrix, u denotes a displacement vector, f denotes a load vector, and k denotes a time step.

$${\underbrace{( M + Δ {t}^{2} K )}}_{A} {u}^{k + 1} = {\underbrace{M ( 2 {u}^{k} + {u}^{k - 1} )}}_{f} \qquad ( 3 )$$

$$Au = f \qquad ( 4 )$$

Similar methods can be applied to phenomena other than phenomena that can be expressed by continuum mechanics. For example, differential equations describing phenomena such as electrical circuits and thermal circuits can also be expressed in matrix form.

When the matrix A (=M+Δt²K) in equation (4) above expressed by the mass matrix M and the stiffness matrix K is not a symmetric matrix or not a Hermitian matrix, the matrix A can be symmetrized by adding a transposed matrix of the matrix, as shown in equation (5) below.

$$( \begin{matrix}0 & {A}^{T} \\ A & 0\end{matrix} ) ( \begin{matrix}u \\ {u}^{′}\end{matrix} ) = ( \begin{matrix}{f}^{′} \\ f\end{matrix} ) \qquad ( 5 )$$

In equation (5) above, u′ and f′ are optional as they do not affect the original matrix form. Although the dimension of the symmetrized matrix increases, since the symmetrized matrix is a sparse matrix, the symmetrized matrix can be reduced by utilizing a sparse solver.

In general, symmetric or Hermitian matrices can be diagonalized to obtain eigenvalues and eigenvectors.

Subsequently, as a preprocessing step, the analysis unit 123 decomposes the matrix in matrix form by linear summation with respect to the tensor product of Pauli operators to represent the matrix as a quantum circuit. The analysis unit 123 tentatively obtains eigenvalues and eigenvectors by using quantum circuits.

The processing described so far corresponds to the quantum operation (the above-described F1) including the operation of decomposing the matrix. Subsequently, the analysis unit 123 performs the optimization process (the above-described F2) on the results of the quantum operation.

Specifically, the analysis unit 123 updates the eigenvalues and the eigenvectors by means of a classical optimization algorithm (optimization algorithm with classical computation) based on the variational principle, with an optimization index (also called energy function, value function, or cost function) as an objective function, the optimization index being an index of the variational principle.

The analysis unit 123 can obtain the response variable y being the phenomenon response by combining the eigenvalues and the eigenvectors. At a stage when the sampling data set (x, y) including response variable y has been accumulated to a pre-specified number, the analysis unit 123 executes an inverse analysis algorithm.

The inverse analysis algorithm is a process to reconcile sampling data with monitoring data. For example, the analysis unit 123 repeatedly performs the analysis process while updating a probability distribution for the variable x until the sampling data is consistent with the monitoring data. For example, the probability distribution is updated to a posterior distribution, similar to the process by the above update unit 128-3. The sampling data (sampling data including the response variable y) when consistent with the monitoring data is output as the result of the analysis process.

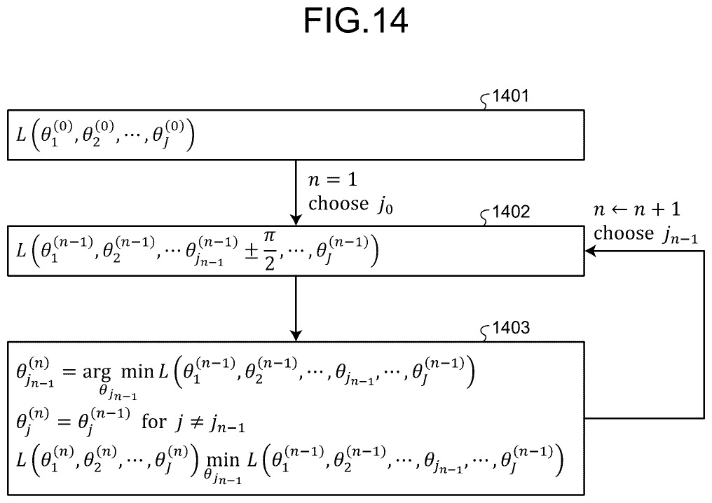

FIG. 14 is a schematic diagram illustrating an example of the procedure of quantum-classical hybrid computation. An index 1401 corresponds to an initial value of an optimization index. Calculations 1402 and 1403 correspond to a variational quantum algorithm (the above-described function F1) and an optimization algorithm (the above-described function F2), respectively.

A variational parameter θ is a parameter set related the state of a quantum bit, J is the number of parameters, and L is an optimization index in the variational principle. A state quantity (unknown vector u) for a phenomenon of a complex system is extracted from an exhaustive combinatorial set of quantum bit states through a classical optimization calculation (calculation 1403).

The following is an example of how a matrix correlated with a Hamiltonian (can also be converted to a Lagrangian) for phenomena in complex systems can be decomposed by linear sums over tensor products of Pauli operators, and thus represented as a quantum circuit.

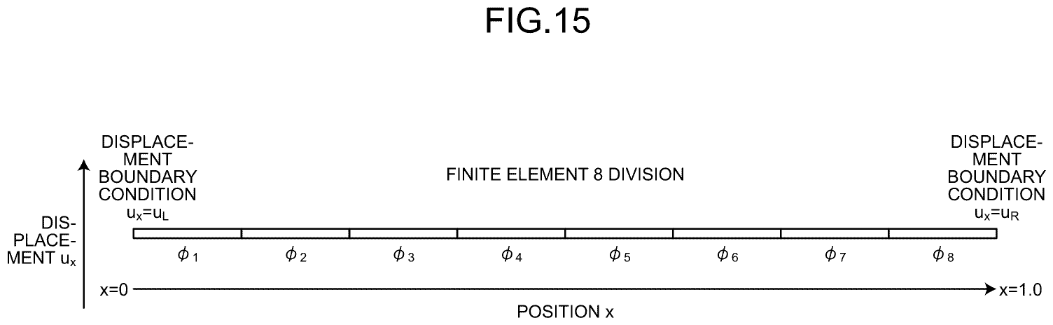

The following describes an example of a string vibration problem described by a Poisson equation and analyzed numerically by FEM. More specifically, the following describes a case where strings are modeled in one dimension and divided into eight elements. FIG. 15 is a schematic diagram illustrating an example of a string modeled in one dimension and divided into eight finite elements. Note that φ₁ to φ₈ under elements represent trial functions of the Galerkin method.

The equation representing the behavior of the string is expressed by a one-dimensional wave equation as shown in equation (6) below.

$$\begin{matrix}\frac{{\partial }^{2} u}{\partial {t}^{2}} - \frac{{\partial }^{2} u}{\partial {x}^{2}} = 0 & x ∈ ( 0 , 1 ) \\ BOUNDARY CONDITION & u ( {x}_{L} , t ) = {u}_{L} \\ & u ( {x}_{R} , t ) = {u}_{R} \\ INITIAL CONDITION & u ( x , 0 ) = {u}_{0}\end{matrix} \} \qquad ( 6 )$$

When the boundary and initial conditions are the conditions described within equation (6) above, the one-dimensional wave equation can be expressed by the trial function φ (and shape function) of the Galerkin method in a weak form shown in equation (7) below.

$${\int }_{{x}_{L}}^{{x}_{R}} \frac{{\partial }^{2} u}{\partial {t}^{2}} ∅ dx + {\int }_{{x}_{L}}^{{x}_{R}} \frac{\partial u}{\partial x} \frac{d ∅}{dx} dx = 0 \qquad ( 7 )$$

The weak form can be expressed in matrix form similar to equation (4) above by discretizing, as u^{k}, the displacement at time step Δt and k steps with respect to time.

In the case of the example in FIG. 15, a matrix A is an 8×8-dimensional symmetric matrix and is represented by M+Δt²K by using a mass matrix M and a stiffness matrix K obtained by the following procedure.

When discretized by a Newmark-β method in the time direction, the weak form is expressed as in equations (8) to (10) below. In equations (8) to (10) below, when β=0, it is an explicit solution method by a central difference method, and when β=1/6, it is an implicit solution method by a linear acceleration method.

$$( \frac{1}{βΔ {t}^{2}} M + K ) {u}^{k + 1} = M ( \frac{1}{βΔ {t}^{2}} {u}^{k} + \frac{1}{βΔ t} {\dot{u}}^{k} + ( \frac{1}{2 β} - 1 ) {\ddot{u}}^{k} ) \qquad ( 8 )$$

$${\dot{u}}^{k + 1} = \frac{1}{βΔ {t}^{2}} ( {u}^{k + 1} - {u}^{k} ) - \frac{1}{βΔ t} {\dot{u}}^{k} - ( \frac{1}{2 β} - 1 ) {\ddot{u}}^{k} \qquad ( 9 )$$

$${\ddot{u}}^{k + 1} = \frac{1}{βΔ t} ( {u}^{k + 1} - {u}^{k} ) + ( 1 - \frac{γ}{2 β} ) {\dot{u}}^{k} + ( 1 - \frac{γ}{2 β} ) {\ddot{u}}^{k} \qquad ( 10 )$$

In the case of the example in FIG. 15, the stiffness matrix K and the mass matrix M are each divided into 8 elements, so as h=1/8, the stiffness matrix K and the mass matrix M are represented by 9×9-dimensional symmetric matrices as in equations (11) and (12) below, respectively. Note that h denotes the unit space dimension of a finite element.

$$K = \frac{1}{h} [ \begin{matrix}\begin{matrix}1 & - 1 & 0 \\ - 1 & 2 & - 1 \\ 0 & 0 & 2\end{matrix} & … & 0 \\ ⋮ & ⋱ & ⋮ \\ 0 & … & \begin{matrix}2 & - 1 & 0 \\ - 1 & 2 & - 1 \\ 0 & - 1 & 1\end{matrix}\end{matrix} ] \qquad ( 11 )$$

$$M = \frac{1}{2 h} [ \begin{matrix}\begin{matrix}1 & 0 & 0 \\ 0 & 2 & 0 \\ 0 & 0 & 2\end{matrix} & … & 0 \\ ⋮ & ⋱ & ⋮ \\ 0 & … & \begin{matrix}2 & 0 & 0 \\ 0 & 2 & - 1 \\ 0 & 0 & 1\end{matrix}\end{matrix} ] \qquad ( 12 )$$

When applying a Dirichlet boundary condition u₁=u₉=0, the stiffness matrix K and the mass matrix M are represented by 8×8-dimensional symmetric matrices as in equations (13) and (14) below, respectively.

$$K = \frac{1}{h} [ \begin{matrix}\begin{matrix}2 & 1 \\ 1 & 2\end{matrix} & … & 0 \\ ⋮ & ⋱ & ⋮ \\ 0 & … & \begin{matrix}2 & 1 \\ 1 & 2\end{matrix}\end{matrix} ] \qquad ( 13 )$$

$$M = \frac{1}{h} [ \begin{matrix}\begin{matrix}1 & 0 \\ 0 & 1\end{matrix} & … & 0 \\ ⋮ & ⋱ & ⋮ \\ 0 & … & \begin{matrix}1 & 0 \\ 0 & 1\end{matrix}\end{matrix} ] \qquad ( 14 )$$

In general, the matrix A serving as a Hermitian matrix can be expressed as in equations (15) and (16) below.

$$A = {\sum }_{{j}_{1} , {j}_{2} , … {j}_{n}} {h}_{{j}_{1} {j}_{2} … {j}_{n}} \cdot {σ}_{{j}_{1}} ⊗ {σ}_{{j}_{2}} ⊗ … ⊗ {σ}_{{j}_{n}} \qquad ( 15 )$$

$${h}_{{j}_{1} {j}_{2} … {j}_{n}} = \frac{1}{{2}^{n}} Tr ( ( {σ}_{{j}_{1}} ⊗ {σ}_{{j}_{2}} ⊗ … ⊗ {σ}_{{j}_{n}} ) A ) \qquad ( 16 )$$

In equations (15) and (16) above, σ represents a Pauli matrix (Pauli operator). A symbol with an x in a circle represents a tensor product. n represents the number of quantum gates. The size N of the matrix is N=2ⁿ. jᵢ represents the type of gate (for example, Pauli gates X, Y, Z and I). Tr represents a matrix trace.

When considering each of the stiffness matrix K and the Hermitian matrix A to have a diagonal term and an off-diagonal term Aₘ, these matrices K and A can be expressed by equations (17) and (18) below, respectively.

$$K = 2 I + {A}_{m} \qquad ( 17 )$$

$$A = M + Δ {t}^{2} K = ( 1 + 2 Δ {t}^{2} ) I + {A}_{m} \qquad ( 18 )$$

In the present case, the diagonal term can be expressed as a constant multiple of a unit matrix I (in a complex case, the Pauli gate Z is used). The non-diagonal term Aₘ can be expressed as a combination of Pauli gates (especially X or Y).

As an example, considering the case of two quantum bits, the off-diagonal term A₂ can be expressed by a combination of Pauli matrices as shown in equation (19) below.

$$\begin{matrix}{A}_{2} = I ⊗ X + \frac{1}{2} ( X ⊗ X + Y ⊗ Y ) \\ = ( \begin{matrix}0 & 1 & 0 & 0 \\ 1 & 0 & 1 & 0 \\ 0 & 1 & 0 & 1 \\ 0 & 0 & 1 & 0\end{matrix} )\end{matrix} \qquad ( 19 )$$

Similarly, the off-diagonal term A₃ for the case of three quantum bits can be expressed by a combination of Pauli matrices as shown in equation (20) below.

$$\begin{matrix}{A}_{3} = ( \begin{matrix}{A}_{2} & 0 \\ 0 & {A}_{2}\end{matrix} ) + ( \vert 011 〉 〈 100 \vert + \vert 100 〉 〈 011 \vert ) \\ = I ⊗ I ⊗ X + \frac{1}{2} ( I ⊗ X ⊗ X + I ⊗ Y ⊗ Y ) + \\ \frac{1}{4} ( X ⊗ X ⊗ X - X ⊗ Y ⊗ Y + Y ⊗ X ⊗ X + Y ⊗ Y ⊗ X )\end{matrix} \qquad ( 20 )$$

In this way, by decomposing the matrix A serving as the Hermitian matrix related to physical quantity such as the Hamiltonian that can describe a phenomenon, into a product of Pauli matrices, a quantum circuit corresponding to the matrix A can be prepared. In the present embodiment, the method of decomposing the matrix A is not unique, and the quantum-classical hybrid calculation is performed while correcting the method of decomposing the matrix A so as to converge through optimization using classical calculation.

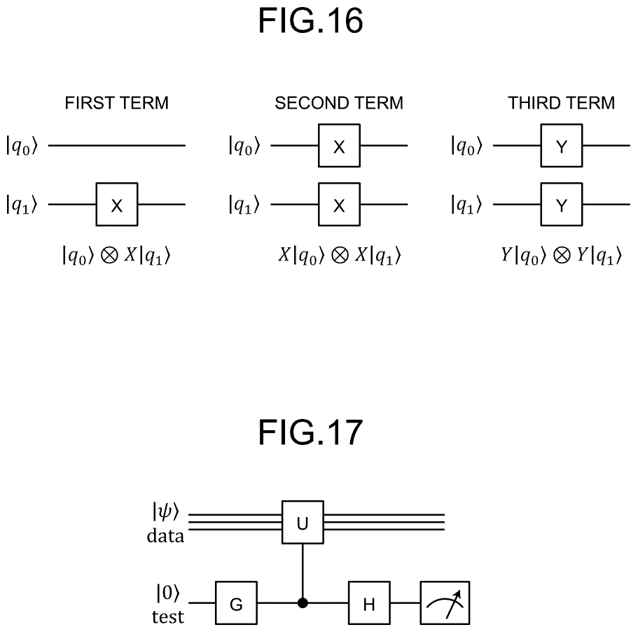

FIG. 16 is a schematic diagram illustrating an example of a quantum circuit corresponding to the matrix A. FIG. 16 illustrates an example of a quantum circuit corresponding to the off-diagonal term A₂ for the case of two quantum bits.

When the two quantum bits are |q₀> and |q1>, respectively, the off-diagonal term A₂ can be expressed by equation (21) below. The first, second, and third terms on the right side of equation (21) below correspond to the quantum circuits illustrated in FIG. 16, respectively.

$$\begin{matrix}{A}_{2} ( \vert {q}_{0} 〉 ⊗ \vert {q}_{1} 〉 ) = ( I ⊗ X + \frac{1}{2} ( X ⊗ X + Y ⊗ Y ) ) ( \vert {q}_{0} 〉 ⊗ \vert {q}_{1} 〉 ) \\ = \vert {q}_{0} 〉 ⊗ X \vert {q}_{1} 〉 + \frac{1}{2} ( X \vert {q}_{0} 〉 ⊗ X \vert {q}_{1} 〉 + Y \vert {q}_{0} 〉 ⊗ Y \vert {q}_{1} 〉 )\end{matrix} \qquad ( 21 )$$

Note that any quantum gate can be described as a combination of Pauli matrices. Although the off-diagonal term Aₘ in the Hermitian matrix A is expressed using only the Pauli matrix, other quantum gates may be used together to construct a quantum circuit. In general, a Hadamard gate H, a control NOT (control X) gate C\hat{ }_{X}, and rotation gates R _{X}, R\hat{ }_{Y}, R\hat{ }_{Z}, and the like around each axis are used.

In order to calculate a cost function (optimization index), an expected value of each operator needs to be calculated, and to this end, a quantum circuit called a Hadamard test is used. FIG. 17 is a schematic diagram illustrating an example of a configuration of a quantum circuit for a Hadamard test. FIG. 17 illustrates an example of the quantum circuit for a Hadamard test that calculates an expected value <ψ|U|ψ> for an optional state |ψ> and a unitary matrix U. In FIG. 17, a gate G is the Hadamard gate H or the rotational gate R\hat{ }_{X} (π/2).

In the Hadamard test, in addition to the optional state |ψ>, a test bit |0> is prepared for measuring the expected value. The gate G (the Hadamard gate H when measuring the real part of the expected value or the rotational gate R\hat{ }_{X}(π/2) when measuring the imaginary part of the expected value) is applied to the test bit, and then a control U-gate is applied to the test bit as a control bit. Finally, measurement is performed after the Hadamard gate H is applied to the test bit. When the probability that the test bit is |0> is P0 and the probability that the test bit is |1> is P1, the expected value is calculated by the calculation shown in equation (22) below.

$${P}_{0} - {P}_{1} = \{ \begin{matrix}Re ( 〈 ψ \vert U \vert ψ 〉 ) & ( IN A CASE OF G = H ) \\ Im ( 〈 ψ \vert U \vert ψ 〉 ) & ( IN A CASE OF G = {R}_{X} ( π / 2 ) )\end{matrix} \qquad ( 22 )$$

The analysis unit 123 calculates the cost function by using the above method and modifies the unknown vector u (displacement vector u) to minimize the value of the cost function. This allows the solution of the differential equation to be obtained.

The following describes an example of applying the analysis process to resilience management. The following describes an example of resilience management of infrastructure systems (for example, storage battery systems). The application of the analysis process is not limited to the resilience management and the analysis process may be applied to any other process. For example, the analysis process can be applied to analysis, visualization, and control to juxtapose a plurality of values such as environmentality, economic efficiency, and resilience toward the implementation of a circular economy.

In a large-scale storage battery system, tens of thousands or more battery cells are connected in multiple series and multiple parallel to form a circuit (network) network for current and voltage (resistors, coils, capacitors) and also form a circuit (network) network for heat.

Temporal and spatial waveform patterns of charging and discharging vary according to usage conditions and cooling performance conditions. Depending on the cooling performance, temperature irregularities may occur between cells. Battery cell degradation is highly dependent on the number of charge/discharge cycles, state of charge (SOC), C-rate, temperature, and the like.

Candidate configurations and scenarios for a target storage battery system include a combination of the following items.
Structure/configuration/layout conditions
Cooling system and cooling performance conditions
Various current waveform patterns or voltage waveform patterns
Various temperature waveform patterns dependent on cooling performance
Correlation conditions between charging/discharging conditions and temperature conditions
Percentage of charge remaining when charging
Conditions for interrupting charging without waiting for full charge
Conditions for leaving period of time between charging and discharging
Timing of maintenance and update such as reuse/refurbish/repurposing

In the present embodiment, a vast number of possible scenarios are typified, and for each group of scenarios, a small number of variables are used for controlling a target system such that temperature irregularities are suppressed and battery cell degradation is suppressed for a longer life. Examples of the typification of scenario groups include scenarios with or without periodic maintenance and updates, scenarios where the cooling system is air-cooled, and scenarios where the cooling system is water-cooled.

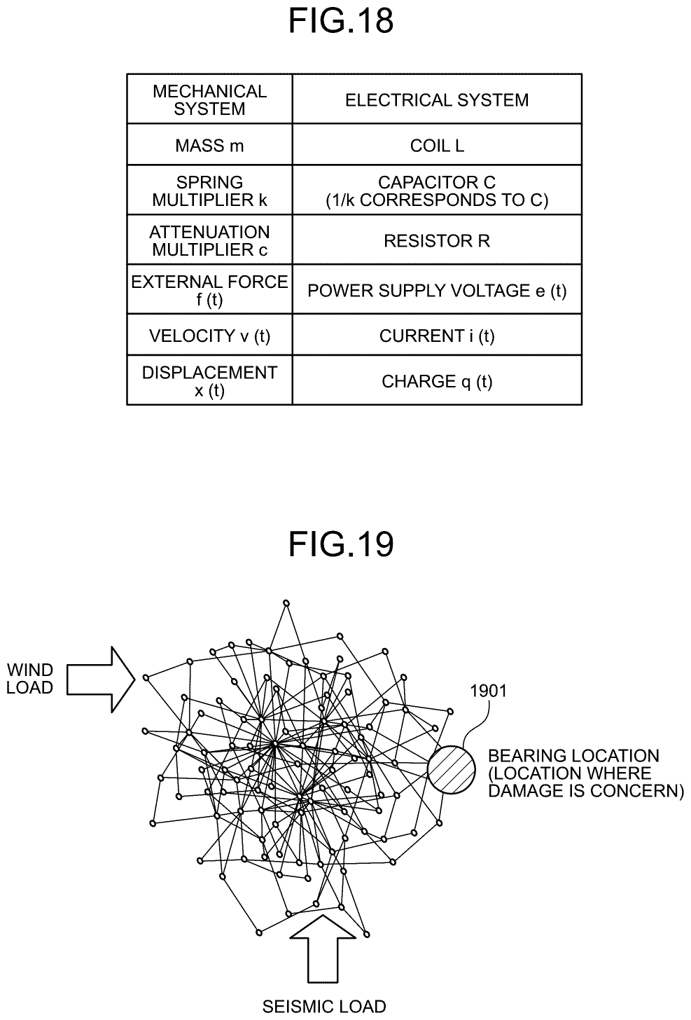

FIG. 18 is a schematic diagram illustrating a correspondence between a vibration model of a mechanical system and a vibration model of an electrical system. The vibration model of the mechanical system is a model to which differential equations based on continuum mechanics can be applied, for example, a vibration model of a mass-spring-damper system. As illustrated in FIG. 18, since a correspondence is present between the vibration model of the mechanical system and the vibration model of the electrical system, the above numerical solution method for differential equations related to continuum mechanics can be applied to the analysis of electrical circuits as well.

For example, the differential equations for each circuit network (such as current and voltage circuit networks and thermal circuit networks) in a storage battery system can each be expressed in matrix form as shown in equation (4) above. In the case of the storage battery system, each element of the matrix form corresponds, for example, as follows.
Matrix A: Resistor, coil, capacitor (capacitance)
Vector u: Charge or current
Vector f: Voltage

Equations expressed in the matrix form can be reduced by using orthogonal eigenexpansions. The following is an example of applying orthogonal eigenexpansions to a second-order differential equation of a multi-mass system and speeding up the equation through reduction.

The equation of motion for multi-degree-of-freedom damped forced vibration is expressed as shown in equation (23) below. Solving equation (23) below requires calculation of an inverse matrix, which is computationally time-consuming. In equation (23) below, u(t) is a displacement, a matrix M is a mass matrix, a matrix C is a damping matrix, a matrix K is a stiffness matrix, and F(t) is a time-dependent excitation load.

$$[ M ] \{ \ddot{u} ( t ) \} + [ C ] \{ \dot{u} ( t ) \} + [ K ] \{ u ( t ) \} = \{ F ( t ) \} \qquad ( 23 )$$

The actual displacement u(t) is transformed by using a transformation matrix q as shown in equation (24) below. In equation (24) below, ξ(t) is a reduced displacement.

$$\{ u ( t ) \} = [ ∅ ] \{ ξ ( t ) \} \qquad ( 24 )$$

The transformation matrix φ is defined as shown in equation (25) below. In equation (25) below, {φⱼ} (j=1, . . . , N) is a feature vector. The equation to be solved is expressed as shown in equation (26) below.

$$[ ∅ ] ≡ [ \{ {∅}_{1} \} , ⋯ , \{ {∅}_{N} \} ] \qquad ( 25 )$$

$${[ ∅ ]}^{T} [ M ] [ ∅ ] \{ \ddot{ξ} ( t ) \} + {[ ∅ ]}^{T} [ C ] [ ∅ ] \{ \dot{ξ} ( t ) \} + {[ ∅ ]}^{T} [ K ] [ ∅ ] \{ ξ ( t ) \} = {[ ∅ ]}^{T} \{ F ( t ) \} \qquad ( 26 )$$

The following is a case of using, as feature vectors, eigenvectors obtained from eigenvalue analysis as shown in equation (27) below. Note that ω is a natural frequency.

$$[ K ] \{ u \} - {ω}^{2} [ M ] \{ u \} = 0 \qquad ( 27 )$$

{φj} is an eigenvector corresponding to a j-th eigenvalue obtained by the eigenvalue analysis. Using the eigenvector, the stiffness and mass matrices are diagonalized. The damping matrix is generally not diagonalized, but the following equation (28) is established when the damping matrix is diagonalized.

$$\begin{matrix}{[ ∅ ]}^{T} [ M ] [ ∅ ] = diag ( {m}_{1} , … , {m}_{N} ) \\ {[ ∅ ]}^{T} [ C ] [ ∅ ] = diag ( {c}_{1 ,} … , {c}_{N} ) \\ {[ ∅ ]}^{T} [ K ] [ ∅ ] = diag ( {k}_{1} , … , {k}_{N} )\end{matrix} \qquad ( 28 )$$

Using these results, the matrix of the equation of motion has only diagonal components, and the equation of motion corresponding to a j-th eigenmode is expressed by an ordinary differential equation shown in equation (29) below. ξⱼ and ωⱼ represent a mode damping ratio and a natural frequency, respectively, obtained from equation (30) below.

$$\ddot{{ξ}_{j}} ( t ) + 2 {ϛ}_{j} {ω}_{j} {\dot{ξ}}_{j} ( t ) + {ω}_{j}^{2} {ξ}_{j} ( t ) = \frac{{f}_{j} ( t )}{{m}_{j}} , {f}_{j} ( t ) = {\{ {∅}_{j} \}}^{T} \{ F ( t ) \} \qquad ( 29 )$$

$${ϛ}_{j} = \frac{{c}_{j}}{2 {m}_{j} {ω}_{j}} \qquad 30 )$$

$$ωj = \sqrt{\frac{{k}_{j}}{{m}_{j}}}$$

When initial conditions are expressed in equation (31) below, equation (29) above is expressed as shown in equation (32) below by using a Duhamel integral (convolution integral). ω_{d} is a damped natural frequency defined by equation (33) below.

$$ξ ( 0 ) = 0 , \dot{ξ} ( 0 ) = 0 \qquad ( 31 )$$

$${ξ}_{j} ( t ) = \frac{1}{{m}_{j} {ω}_{d}} {\int }_{0}^{t} {f}_{j} ( τ ) {e}^{- {ϛ}_{j} {ω}_{j} ( t - τ )} sin \{ {ω}_{d} ( t - τ ) \} dτ \qquad ( 32 )$$

$${ω}_{d} = {ω}_{j} \sqrt{1 - {ϛ}_{j}^{2}} \qquad ( 33 )$$

Equation (32) above can be expanded as shown in equations (34) to (37) below.

$$sin [ {ω}_{d} ( t - τ ) ] = sin ( {ω}_{d} t ) cos ( {ω}_{d} τ ) - cos ( {ω}_{d} t ) sin ( {ω}_{d} τ ) \qquad ( 34 )$$

$${ξ}_{j} ( t ) = [ \frac{1}{{m}_{j} {ω}_{d}} {\int }_{0}^{t} \{ {f}_{j} ( τ ) {e}^{- {ϛ}_{j} {ω}_{j} ( t - τ )} cos ( {ω}_{d} τ ) \} d τ ] sin ( {ω}_{d} t ) - [ \frac{1}{{m}_{j} {ω}_{d}} {\int }_{0}^{t} \{ f , ( τ ) {e}^{- {ϛ}_{j} {ω}_{j} ( t - τ )} sin ( {ω}_{d} τ ) \} d τ ] cos ( {ω}_{d} t ) = {A}_{j} ( t ) sin ( {ω}_{d} t ) - {B}_{j} ( t ) cos ( {ω}_{d} t ) \qquad ( 35 )$$

$${A}_{j} ( t ) ≡ {A}_{j} ( t - Δ t ) + {\int }_{t - Δ t}^{t} \{ {f}_{j} ( τ ) {e}^{- {ϛ}_{j} {ω}_{j} ( t - τ )} cos ( {ω}_{d} τ ) \} d τ \qquad ( 36 )$$

$${B}_{j} ( t ) ≡ {B}_{j} ( t - Δ t ) + {\int }_{t - Δ t}^{t} \{ {f}_{j} ( τ ) {e}^{- {ϛ}_{j} {ω}_{j} ( t - τ )} sin ( {ω}_{d} τ ) \} d τ \qquad ( 37 )$$

The analysis unit 123 can calculate the displacement u (t) by substituting the obtained ξⱼ into equation (24) above. In the absence of attenuation, ξⱼ=0 and integration is easily possible. This simplification using the feature vector allows differential equations to be solved more quickly.

The Duhamel integral may not be calculated efficiently. In such a case, Nigam's method may be used instead of the Duhamel integral.

When the damping matrix is not diagonalized, an error increases. In circuit simulation, when inductance is negligible compared to resistance and capacitance, an equivalent circuit is described by a first-order differential equation as shown in equation (38) below.

$$C \dot{x} = Kx + f \qquad ( 38 )$$

When equation (38) above is multiplied by C⁻¹, equation (39) below is obtained. The formal solution of equation (39) below is expressed by the Duhamel integral shown in equation (40) below.

$$\dot{x} = {C}^{- 1} K x + {C}^{- 1} f \qquad ( 39 )$$

$$x ( t ) = exp ( ( t - {t}_{0} ) {C}^{- 1} K ) x ( {t}_{0} ) + {\int }_{{t}_{0}}^{t} exp ( ( t - {t}_{0} ) {C}^{- 1} K ) {C}^{- 1} f ( τ ) d τ \qquad ( 40 )$$

Using an eigenvalue λⁱ and an eigenvector φᵢ(1≤i≤g) obtained from equation (41) below, equation (42) below is established.

$$C \dot{x} = Kx \qquad ( 41 )$$

$${C}^{- 1} K {ϕ}_{i} = {λ}_{i} {ϕ}_{i} \qquad ( 42 )$$

Using g eigenvalues, equation (42) above is expressed in equation (43) below. In equation (43) below, Λ=diag(λ₁, . . . , λ_{g}) and Φ=φ₁, . . . , φ_{g}.

$${C}^{- 1} K Φ = ΛΦ \qquad ( 43 )$$

Using the eigenvector, a portion related to the exponential function included in equation (40) above can be calculated as shown in equation (44) below.

$$exp ( ( t - {t}_{0} ) {C}^{- 1} K ) = {Φ}^{- 1} exp ( Λ ( t - {t}_{0} ) ) Φ \qquad ( 44 )$$

Defining Φᵢ=(0, . . . , φᵢ, . . . , 0)φ⁻¹, equation (40) above can be simplified as shown in equation (45) below and can be solved more quickly.

$$x ( t ) = {\sum }_{i = 1}^{n} {Φ}_{i} exp ( {λ}_{i} ( t - {t}_{0} ) ) x ( {t}_{0} ) + {\int }_{{t}_{0}}^{t} {\sum }_{i = 1}^{n} {Φ}_{i} exp ( {λ}_{i} ( t - {t}_{0} ) ) {C}^{- 1} f ( τ ) d τ \qquad ( 45 )$$

In the second-order differential equation, when the effect of the off-diagonal component of the damping matrix is significant and the stiffness and mass matrices are not negligible, state equations are defined as shown in equations (46) to (48) below.

$$\dot{x} = A x + f \qquad ( 46 )$$

$$x = [ \begin{matrix}u \\ \dot{u}\end{matrix} ] \qquad ( 47 )$$

$$A = [ \begin{matrix}0 & I \\ {M}^{- 1} K & {M}^{- 1}\end{matrix} ] \qquad ( 48 )$$

These state equations can also be simplified and solved more quickly by using the Duhamel integral.

A heat transfer path can be replaced with the same equation as in an electric circuit by a thermal network method. Accordingly, the above method can also be applied to heat transfer calculations.

The following describes an example of controlling a storage battery system by using the complex network as illustrated in FIG. 6. In this case, for example, in the complex network in FIG. 6, the input variables x (analysis condition variables x) are the usage conditions (such as cooling performance conditions) and the load waveform of the storage battery system, and the response variables y are current, voltage and temperature.

At this time, when the features z₁ and z₂ can be extracted, nodes (nodes 601 to 604 in FIG. 6) with large correlations with the features z₁ and z₂ can be focused, and temperature irregularities can be controlled to be suppressed for the input variable x related to these nodes. This facilitates management to suppress the degradation of a battery and extend the life of the battery.

From the relationship between the input variables x and the features z, for example, the feature z₁ can be interpreted as a feature for suppressing temperature irregularities, and the feature z₂ can be interpreted as a feature related to power consumption due to the operation of cooling system equipment. This also enables efficient management to implement both a longer life by suppressing temperature irregularities and minimization of carbon footprint by reducing power consumption.

The relationship among the extracted features z, the input variable x, and the response variable y may be represented, for example, by a causal correlation model or by only a probability distribution. The following describes an example of controlling the response variable y for each of these two cases.

When the relationship among the extracted features z, the input variable x, and the response variable y is represented by a causal correlation model, differential equations for the feature z and the input variable x can be obtained. Accordingly, for example, the system control unit 127-3 can efficiently control the response variable y using the input variable x by controlling the feature z using the input variable x.

The control method used in this case includes proportional-integral-differential (PID) control, model prediction control, consensus control, and the like depending on the number of response variables y to be controlled and the number of input variables x that can be used as control variables.

For example, simple PID control is used when one response variable y is controlled by using one input variable x as the control variable. In this case, more efficient control can be implemented by selecting a node of the response variable y to be controlled on the basis of the previously extracted feature z.

In cases where plural response variables y are controlled by a small number of input variables x, model predictive control is used. By using the model predictive control, not only can complex dynamics including the response variables y be controlled, but also restrictions such as operating the response variables y within a given range can be handled directly. The life of the cell can also be used as an objective function. Also at this time, efficient control can be implemented by selecting a node of the response variable y to be controlled on the basis of the feature z.

The consensus control is also used when plural response variables y are controlled by plural input variables x. The consensus control is especially effective when the entire storage battery system is controlled by controlling each of a large number of cells. At this time, efficient control can be implemented by using the relationship between the feature z and the response variable y in designing the control law for each cell.

In the case of control that aims to maximize the life of the entire storage battery system based on the waveform of each cell, the model predictive control can be used for maximizing the life. At this time, by using the relationship between the extracted feature z and the response variable y, a model handled by the model predictive control can be described by the feature z instead of the response variable y. This allows for efficient control due to the smaller dimension of the model.

The following describes an example in which the relationship among the feature z, the input variable x, and the response variable y is represented only by a probability distribution model. In this case, the operating range of the response variable y can be set using the feature z as an index. By defining the desired range of the features z and sampling the response variable y, the desired operating range for the response variable y can be obtained. By using the input variable x to control the response variable y to be in this operating range, the feature z can also be indirectly controlled.

Also in this case, the PID control, the model predictive control, the consensus control, and the like can be applied depending on the number of response variables y to be controlled and the number of input variables x to be controlled. For example, when temperature irregularities are controlled, an operating range for the temperature distribution of the response variable y can be obtained through sampling by using the feature z related to the temperature irregularities. Subsequently, the temperature irregularities can be controlled by controlling the temperature distribution of the response variable y to be in the obtained operating range by the input variable x such as the amount of rotation of a fan.

In this way, efficient control can be implemented by using the relationship between the extracted feature z and the response variable y when controlling the storage battery system.

The following describes an example in which the present embodiment is applied to resilience management of a drive train structure of a wind power plant.

For example, when a wind power plant is subjected to wind action and seismic loads, a combination of load waveforms and shaft misalignment due to installation tolerances may trigger emergent excessive load waveforms. Complex networks representing the transfer paths of physical quantities (such as forces) in the drive train may be random networks or free-scale networks depending on the scenario of a combination of system configuration, structure, load conditions, and installation tolerances. Note that the complex networks may also be other small networks or the like. Pre-processing may be performed on the physical quantities, such as assuming pseudo-periods in the waveforms of the wind and seismic loads and representing them with physical quantities at each phase in the pseudo-period.

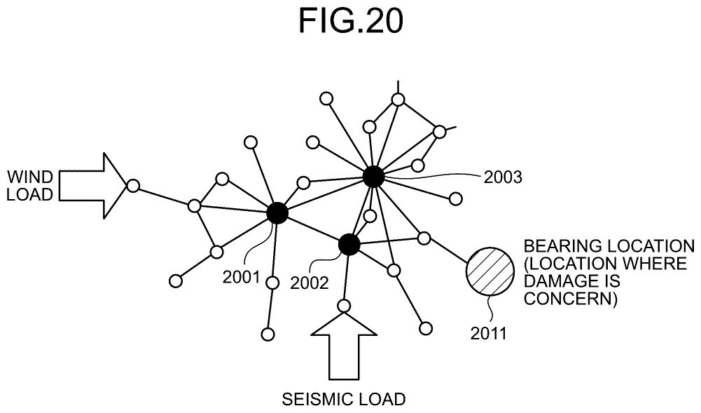

FIG. 19 is a schematic diagram illustrating an example of a random network. FIG. 20 is a schematic diagram illustrating an example of a free-scale network. In FIG. 19, a node 1901 corresponds to a bearing that is a location where damage is a concern. In FIG. 20, nodes 2001 to 2003 correspond to representative nodes with large correlations with features, for example. A node 2011 corresponds to a bearing that is a location where damage is a concern.

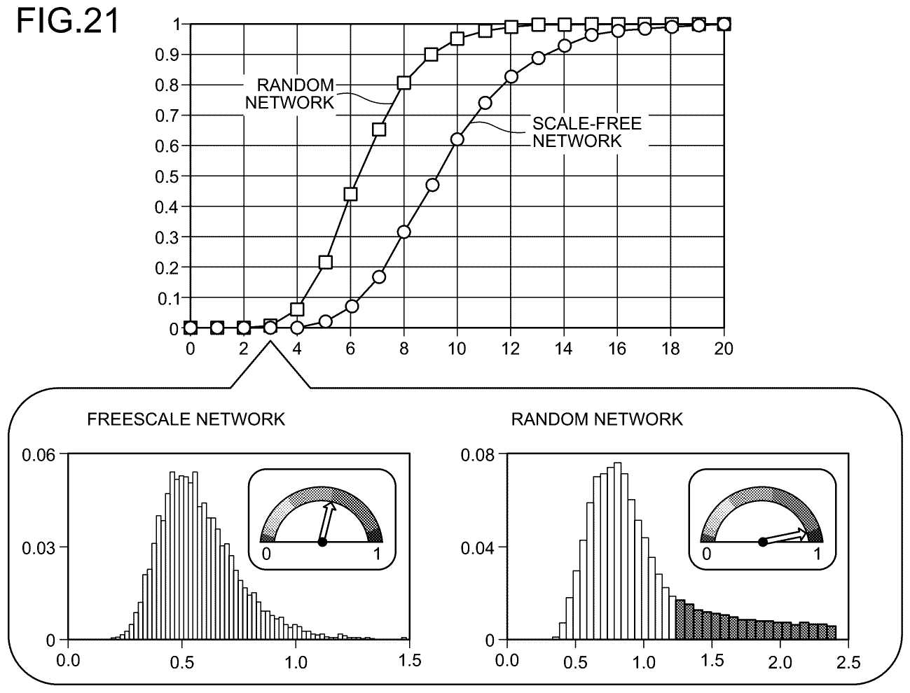

Depending on the form of the complex network, changes in damage probability over time vary significantly. FIG. 21 is a schematic diagram illustrating an example of changes in damage probability over time when the complex network is a random network and when the complex network is a free-scale network. In the upper graph in FIG. 21, a horizontal axis denotes elapsed time (such as years) and a vertical axis denotes predicted damage probability.

The lower graph in FIG. 21 represents a graph where a horizontal axis denotes a cumulative damage value and a vertical axis is a probability density. As shown in the lower graph, a fat-tail phenomenon may occur when the complex network is a random network.

The present embodiment can be applied to the drive train structure of a wind power plant having such characteristics when resilience management for reducing downtime is performed.

For example, when the drive train structure is controlled using the complex network as illustrated in FIG. 6, for example, the input variable x (analysis condition variable x) is the load waveform of the wind action and the seismic loads, and the response variable y is stress occurring in the drive train structure.

At this time, when the features 21 and 22 can be extracted, nodes (nodes 601 to 604 in FIG. 6) with large correlations with the features z1 and z2 are focused and adjusted (for example, by installing a buffer structure to adjust excessive load), thereby buffering excessive load and easily improving availability.

The following describes an example of the configuration of the analysis unit 123 when analyze phenomena is performed by using quantum-inspired calculation or quantum computing. The following describes, as an example, a case where the target system is a large-scale storage battery system. The following describes an example of using the quantum-inspired calculation or the quantum computing for the current-voltage characteristics of a single battery cell constituting the storage battery system.

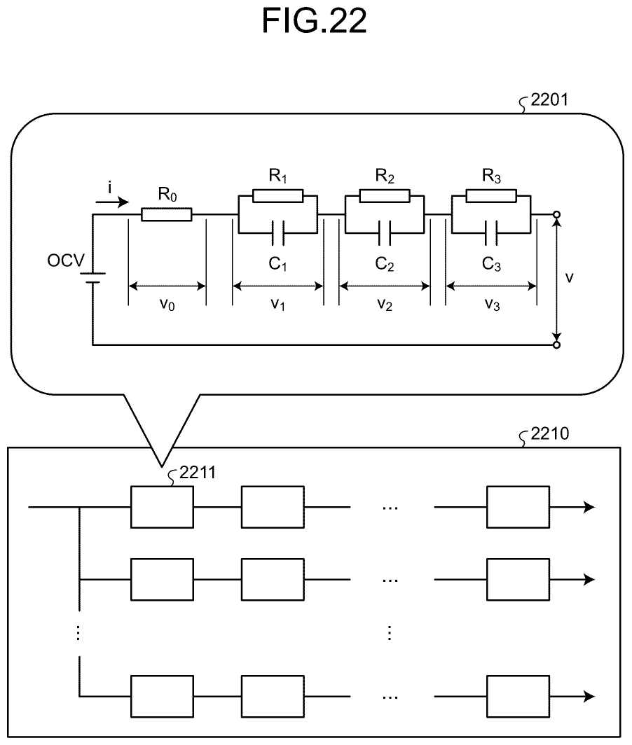

FIG. 22 is a schematic diagram illustrating an example of an equivalent circuit model representing the current-voltage characteristics of each battery cell. A storage battery system 2210 includes a plurality of battery cells 2211. Each battery cell 2211 is represented by an equivalent circuit 2201.

A voltage v (t) of the battery cell 2211 at a time t is given by a circuit equation shown in equation (49) below.

$$v ( t ) = O C V + {R}_{0} \cdot i ( t ) + {v}_{1} ( t ) + {v}_{2} ( t ) + {ν}_{3} ( t ) \qquad ( 49 )$$

$$\frac{d {v}_{1} ( t )}{d t} = - \frac{{v}_{1} ( t )}{{R}_{1} {C}_{1}} + \frac{i ( t )}{{C}_{1}}$$

$$\frac{d {v}_{2} ( t )}{d t} = - \frac{{v}_{2} ( t )}{{R}_{2} {C}_{2}} + \frac{i ( t )}{{C}_{2}}$$

$$\frac{d {v}_{3} ( t )}{dt} = - \frac{{v}_{3} ( t )}{{R}_{3} {C}_{3}} + \frac{i ( t )}{{C}_{3}}$$

In order to calculate the time evolution of battery voltage behavior, it is assumed that a classical computer is used for performing numerical integration in discrete time as shown in equation (50) below. In order to calculate the time evolution of voltages v₁, v₂, and v₃ in each RC parallel element, the rate f(i,vⱼ) of change of each of the voltages v₁, v₂, and v₃ at each time needs to be obtained from ordinary differential equations for v₁, v₂, and v₃.

$$\begin{matrix}{v}_{1} ( t - Δ t ) = {v}_{1} ( t ) + Δ t \cdot f ( i , {v}_{1} ) \\ {v}_{2} ( t - Δ t ) = {v}_{2} ( t ) + Δ t \cdot f ( i , {v}_{2} ) \\ {v}_{3} ( t - Δ t ) = {v}_{3} ( t ) + Δ t \cdot f ( i , {v}_{3} )\end{matrix} \qquad ( 50 )$$

When calculating f(i,vⱼ) by an implicit solution method, any optimization method is used for obtaining f(i,vⱼ) (real number optimal solution) corresponding to any implicit solution scheme.

Hereinafter, the quantum-inspired calculation or the quantum computer can basically handle only binary variables. Therefore, the present embodiment treats the real number optimization problem as a binary variable optimization problem by introducing an approximate representation of real numbers using binary variables. The binary variable optimization problem is, for example, a quadratic unconstrained binary optimization (QUBO) problem.

This makes it possible to use the quantum-inspired calculation or the quantum computer in order to analyze an equivalent circuit exhibiting current-voltage characteristics as illustrated in FIG. 22, for example. For example, the analysis unit 123 can obtain a plurality of response variables y (output data) by converting a real number optimization problem for obtaining the rate of change of a plurality of response variables y into a binary variable optimization problem and solving the binary variable optimization problem by a calculation using the quantum-inspired calculation or the quantum computer.

In particular, by using a quantum-inspired calculation specialized for solving combinatorial optimization problems such as QUBO, or a quantum computer of the quantum annealing type, the behavior of each battery cell 2211 constituting the storage battery system can be analyzed faster than in classical calculations.

When phenomenon analysis is performed using a surrogate model, the analysis unit 123 can perform an analysis process using the method described in, for example, a patent document: Japanese Patent Application Laid-open No. 2022-180873.

As described above, according to the embodiment, analysis, visualization, and control can be more efficiently performed for resilience and the like of a complex system.

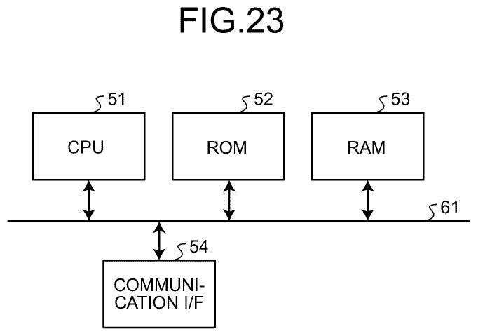

The following describes the hardware configuration of the information processing apparatus of the embodiment with reference to FIG. 23. FIG. 23 is an explanatory diagram illustrating an example of the hardware configuration of the information processing apparatus of the embodiment.

The information processing apparatus of the embodiment includes a control device such as a CPU 51, a storage device such as a read only memory (ROM) 52 and a RAM 53, a communication interface (I/F) 54 connected to a network to perform communication, and a bus 61 for connecting the units to one another.

A computer program executed by the information processing apparatus of the embodiment is preliminarily incorporated in the ROM 52 or the like so as to be provided.

The computer program executed by the information processing apparatus of the embodiment may be a file in an installable format or in an executable format, and be recorded in a computer-readable recording medium, such as a compact disc read only memory (CD-ROM), a flexible disk (FD), a compact disc recordable (CD-R), or a digital versatile disc (DVD), so as to be provided as a computer program product.

The computer program executed by the information processing apparatus of the embodiment may be stored on a computer connected to a network such as the Internet and be downloaded over the network so as to be provided. The computer program executed by the information processing apparatus of the embodiment may be provided or distributed over the network such as the Internet.

The computer program executed by the information processing apparatus of the embodiment enables a computer to function as each unit of the information processing apparatus described above. After the CPU 51 reads the computer program on a main storage device from the computer-readable storage medium, the computer can execute the computer program.

Configuration examples according to the above-described embodiment will be described below.

### (Configuration Example 1)

An information processing apparatus comprising
one or more hardware processors configured to:
   extract multiple features representing characteristics of pieces of second sampling data, the pieces of second sampling data including pieces of first sampling data and pieces of output data obtained by using the pieces of first sampling data as input, the pieces of first sampling data being generated by using a multidimensional first probability distribution representing a distribution of each of pieces of input data related to an object to be analyzed, the pieces of output data representing physical quantity of the object to be analyzed; and
   generate a network model representing a relationship among multiple nodes corresponding to the physical quantity of the object to be analyzed, the multiple nodes including a node corresponding to the extracted features.

### (Configuration Example 2)

The information processing apparatus according to the configuration example 1, wherein the one or more hardware processors is configured to control the object to be analyzed by using the multiple features as control variables.

### (Configuration Example 3)

The information processing apparatus according to the configuration example 1 or 2, wherein the one or more hardware processors is configured to update the first probability distribution by using a monitoring data being the pieces of input data measured from the object to be analyzed.

### (Configuration Example 4)

The information processing apparatus according to any one of the configuration examples 1 to 3, wherein the one or more hardware processors is configured to
modify the first probability distribution to optimize an index of the network model to be generated, and
generate the pieces of first sampling data by using the modified first probability distribution.

### (Configuration Example 5)

The information processing apparatus according to any one of the configuration examples 1 to 4, wherein the one or more hardware processors is configured to
generate pieces of third sampling data on the basis of the multiple features, and
extract the multiple features to optimize an index indicating whether a multidimensional second probability distribution representing a distribution of the pieces of third sampling data is consistent with the first probability distribution.

### (Configuration Example 6)

The information processing apparatus according to any one of the configuration examples 1 to 5, wherein the one or more hardware processors is configured to
perform a quantum operation including an operation of decomposing a matrix based on a Hamiltonian generated from the pieces of first sampling data, and
obtain the pieces of output data by performing an optimization process on results of the quantum operation.

### (Configuration Example 7)

The information processing apparatus according to any one of the configuration examples 1 to 5, wherein the one or more hardware processors is configured to obtain the pieces of output data by
converting a real number optimization problem for obtaining a rate of change of the pieces of first sampling data into a binary variable optimization problem, and
solving the binary variable optimization problem by a calculation using a quantum-inspired calculation or by a calculation using a quantum computer.

### (Configuration Example 8)

The information processing apparatus according to any one of the configuration examples 1 to 7, wherein the one or more hardware processors is configured to generate the pieces of first sampling data from the first probability distribution on the basis of a quantum-inspired calculation, a quantum computing calculation, a Lagrangian Monte Carlo calculation, a Hamiltonian Monte Carlo calculation, or a Markov chain Monte Carlo calculation.

### (Configuration Example 9)

The information processing apparatus according to any one of the configuration examples 1 to 8, wherein the one or more hardware processors is configured to calculate an occurrence probability representing a ratio of the number of sampling data whose corresponding output data satisfying a specific condition to the number of the generated pieces of first sampling data.

### (Configuration Example 10)

The information processing apparatus according to the configuration example 9, wherein the one or more hardware processors is configured to control the object to be analyzed such that the occurrence probability reaches a target value.

### (Configuration Example 11)

The information processing apparatus according to any one of the configuration examples 1 to 10, wherein the one or more hardware processors is configured to generate the pieces of first sampling data by using the first probability distribution.

### (Configuration Example 12)

The information processing apparatus according to any one of the configuration examples 1 to 11, wherein the one or more hardware processors is configured to obtain the pieces of output data by receiving the pieces of first sampling data as input.

### (Configuration Example 13)

The information processing apparatus according to any one of the configuration examples 1 to 10, wherein the one or more hardware processors includes:
a generation circuit to generate the pieces of first sampling data;
an analysis circuit to obtain the pieces of output data; and
a modeling circuit to generate the network model.

### (Configuration Example 14)

An information processing method implemented by a computer, the method comprising:
extracting multiple features representing characteristics of pieces of second sampling data, the pieces of second sampling data including pieces of first sampling data and pieces of output data obtained by using the pieces of first sampling data as input, the pieces of first sampling data being generated by using a multidimensional first probability distribution representing a distribution of each of pieces of input data related to an object to be analyzed, the pieces of output data representing physical quantity of the object to be analyzed; and
generating a network model representing a relationship among multiple nodes corresponding to the physical quantity of the object to be analyzed, the multiple nodes including a node corresponding to the extracted features.

### (Configuration Example 15)

A computer program product comprising a non-transitory computer-readable recording medium on which a computer program is recorded, the program instructing the computer to:
extract multiple features representing characteristics of pieces of second sampling data, the pieces of second sampling data including pieces of first sampling data and pieces of output data obtained by using the pieces of first sampling data as input, the pieces of first sampling data being generated by using a multidimensional first probability distribution representing a distribution of each of pieces of input data related to an object to be analyzed, the pieces of output data representing physical quantity of the object to be analyzed; and
generate a network model representing a relationship among multiple nodes corresponding to the physical quantity of the object to be analyzed, the multiple nodes including a node corresponding to the extracted features.

While embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising
one or more hardware processors configured to:
extract multiple features representing characteristics of pieces of second sampling data, the pieces of second sampling data including pieces of first sampling data and pieces of output data obtained by using the pieces of first sampling data as input, the pieces of first sampling data being generated by using a multidimensional first probability distribution representing a distribution of each of pieces of input data related to an object to be analyzed, the pieces of output data representing physical quantity of the object to be analyzed; and
generate a network model representing a relationship among multiple nodes corresponding to the physical quantity of the object to be analyzed, the multiple nodes including a node corresponding to the extracted features.

2. The information processing apparatus according to claim 1, wherein the one or more hardware processors is configured to control the object to be analyzed by using the multiple features as control variables.

3. The information processing apparatus according to claim 1, wherein the one or more hardware processors is configured to update the first probability distribution by using a monitoring data being the pieces of input data measured from the object to be analyzed.

4. The information processing apparatus according to claim 1, wherein the one or more hardware processors is configured to
modify the first probability distribution to optimize an index of the network model to be generated, and
generate the pieces of first sampling data by using the modified first probability distribution.

5. The information processing apparatus according to claim 1, wherein the one or more hardware processors is configured to
generate pieces of third sampling data on the basis of the multiple features, and
extract the multiple features to optimize an index indicating whether a multidimensional second probability distribution representing a distribution of the pieces of third sampling data is consistent with the first probability distribution.

6. The information processing apparatus according to claim 1, wherein the one or more hardware processors is configured to
perform a quantum operation including an operation of decomposing a matrix based on a Hamiltonian generated from the pieces of first sampling data, and
obtain the pieces of output data by performing an optimization process on results of the quantum operation.

7. The information processing apparatus according to claim 1, wherein the one or more hardware processors is configured to obtain the pieces of output data by
converting a real number optimization problem for obtaining a rate of change of the pieces of first sampling data into a binary variable optimization problem, and
solving the binary variable optimization problem by a calculation using a quantum-inspired calculation or by a calculation using a quantum computer.

8. The information processing apparatus according to claim 1, wherein the one or more hardware processors is configured to generate the pieces of first sampling data from the first probability distribution on the basis of a quantum-inspired calculation, a quantum computing calculation, a Lagrangian Monte Carlo calculation, a Hamiltonian Monte Carlo calculation, or a Markov chain Monte Carlo calculation.

9. The information processing apparatus according to claim 1, wherein the one or more hardware processors is configured to calculate an occurrence probability representing a ratio of the number of sampling data whose corresponding output data satisfying a specific condition to the number of the generated pieces of first sampling data.

10. The information processing apparatus according to claim 9, wherein the one or more hardware processors is configured to control the object to be analyzed such that the occurrence probability reaches a target value.

11. The information processing apparatus according to claim 1, wherein the one or more hardware processors is configured to generate the pieces of first sampling data by using the first probability distribution.

12. The information processing apparatus according to claim 1, wherein the one or more hardware processors is configured to obtain the pieces of output data by receiving the pieces of first sampling data as input.

13. The information processing apparatus according to claim 1, wherein the one or more hardware processors includes:
a generation circuit to generate the pieces of first sampling data;
an analysis circuit to obtain the pieces of output data; and
a modeling circuit to generate the network model.

14. An information processing method implemented by a computer, the method comprising:
extracting multiple features representing characteristics of pieces of second sampling data, the pieces of second sampling data including pieces of first sampling data and pieces of output data obtained by using the pieces of first sampling data as input, the pieces of first sampling data being generated by using a multidimensional first probability distribution representing a distribution of each of pieces of input data related to an object to be analyzed, the pieces of output data representing physical quantity of the object to be analyzed; and
generating a network model representing a relationship among multiple nodes corresponding to the physical quantity of the object to be analyzed, the multiple nodes including a node corresponding to the extracted features.

15. A computer program product comprising a non-transitory computer-readable recording medium on which a computer program is recorded, the program instructing the computer to:
extract multiple features representing characteristics of pieces of second sampling data, the pieces of second sampling data including pieces of first sampling data and pieces of output data obtained by using the pieces of first sampling data as input, the pieces of first sampling data being generated by using a multidimensional first probability distribution representing a distribution of each of pieces of input data related to an object to be analyzed, the pieces of output data representing physical quantity of the object to be analyzed; and
generate a network model representing a relationship among multiple nodes corresponding to the physical quantity of the object to be analyzed, the multiple nodes including a node corresponding to the extracted features.
